(19) United States
(12) Patent Application Publication
(10) Pub. No.: US 2005/0118977 A1
(43) Pub. Date: Jun. 2, 2005

(54) Method, apparatus, and systems for digital radio communication systems

(76) Inventors: Serge Francois Drogi, Phoenix, AZ (US); Hans Dropmann, Emerald Hills, CA (US); Vikas Vinayak, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/727,230

(22) Filed: Dec. 2, 2003

(51) Int. Cl. H04B 1/26

(52) U.S. Cl. 455/323

(57) ABSTRACT

A radio system includes a radio frequency (RF) integrated circuit (IC) and a baseband digital signal processing (DSP) IC. A serial digital interface couples data between the RF IC and the DSP IC to provide a high data rate and low noise. In one embodiment, the RF IC has a single bit sigma delta modulator to convert an analog signal into a serial digital bit stream, and a differential output driver to drive the serial digital bit stream as a differential data signal. In one embodiment, the DSP IC has a differential input receiver to receive the differential data signal and generate the serial digital bit stream therein, a decimator to lower the data rate of the serial digital bit stream and convert it into parallel digital data samples, and a demodulator to digitally demodulate the parallel digital data samples into data words for digital signal processing.

### BACKGROUND OF THE INVENTION

1. Field of the Invention

The embodiments of the invention generally relate to radio communication systems. The embodiments of the invention more particularly relate to radio receiver, transmitter, and transceiver integrated circuits and their interface to baseband integrated circuits.

2. Related Art

In typical cellular radio architecture, the interface between the radio operating at carrier frequencies and the baseband section operating around the signal frequencies is typically an analog signal interface. The analog signal interface was typically preferred over a traditional digital signal interface because it avoided the use of parallel digital signals operating at high frequencies that could otherwise generate noise and interfere with the radio operation.

The radio typically consisted of one or more analog integrated circuits that included active analog filters specifically designed for only one radio transmission standard of a communication system. That is, the active analog filters were dedicated to one communication system and were not adaptable to differing communication system standards. Moreover, the active analog filters consumed power and required considerable silicon area within the integrated circuit.

If most, if not all, active analog filters can be eliminated from the analog integrated circuits of the radio, power can be conserved and die size reduced, leading to lower costs and increased battery usage time in battery operated devices.

Additionally in a receive channel, multi-bit parallel analog to digital converters are often used to convert a baseband analog signal into a parallel binary value representing a digital number. The digital number may then be processed by a digital signal processor. In a transmit channel, multi-bit parallel digital to analog converters may be used. However, the multi-bit parallel analog to digital converters and multi-bit parallel digital to analog converters require significant area over an integrated circuit. Additionally, multi-bit parallel analog to digital converters and multi-bit parallel digital to analog converters are usually manufactured using special silicon manufacturing processes as they are mixed signal devices. The silicon manufacturing processes employed effects the cost of a radio. By eliminating a multi-bit parallel analog to digital converter device and a multi-bit parallel digital to analog converter device, the cost of the radio may be further reduced.

### BRIEF SUMMARY OF THE INVENTION

The embodiments of the invention are briefly described by the claims.

In one embodiment, a system includes a radio frequency integrated circuit and a digital signal processing integrated circuit coupled to the radio frequency integrated circuit. The radio frequency integrated circuit has a single bit sigma delta modulator to convert an analog signal into a serial digital bit stream, and an output driver coupled to the single bit sigma delta modulator to drive the serial digital bit stream to the digital signal processing integrated circuit. The digital signal processing integrated circuit includes an input receiver coupled to the output driver of the radio frequency integrated circuit, a decimator coupled to the input receiver, and a demodulator coupled to the decimator. The input receiver receives the serial digital bit stream from the radio frequency IC. The decimator receives the serial digital bit stream through the input receiver and lowers the sampling rate of the serial digital bit stream for digital signal processing by the digital signal processing integrated circuit. The decimator further converts the serial digital bit stream into parallel digital data samples for further signal processing by the digital signal processing integrated circuit. The demodulator digitally demodulates the parallel digital data samples into data words for further signal processing by the digital signal processing integrated circuit.

In another embodiment, the output driver of the radio frequency integrated circuit translates first voltage levels of a first output voltage swing of the serial digital bit stream into second voltage levels with a second output voltage swing less than the first output voltage swing, and the input receiver translates the second voltage levels of the second output voltage swing into third voltage levels with a third output voltage swing. The third output voltage swing may be greater than the second output voltage swing to provide adequate logic levels within the digital signal processor. In another embodiment, the output driver is double ended and generates a differential signal with a reduced output voltage swing to represent the serial digital bit stream, and the input receiver has a differential input to receive the differential signal with the reduced output voltage swing to represent the serial digital bit stream.

In one embodiment, the output driver is a low voltage differential signaling (LVDS) transmitter and the input receiver is a low voltage differential signaling (LVDS) receiver.

In one embodiment of the system the radio frequency integrated circuit is a receiver and in another embodiment it is a transceiver.

In another embodiment of the invention, a radio frequency integrated circuit includes a variable/switched gain amplifier, a down converter coupled to the variable/switched gain amplifier, a single bit sigma delta modulator coupled to the down converter, and an output driver coupled to the single bit sigma delta modulator. The least one variable/switched gain amplifier couples to an antenna to receive a wireless radio frequency signal. The down converter strips an analog signal from a first selectable carrier frequency of the radio frequency signal. The single bit sigma delta modulator converts the analog signal into a serial digital bit stream. The output driver reduces an output voltage swing of the serial digital bit stream to reduce noise generation as the serial digital bit stream is coupled to another integrated circuit.

In one embodiment, the radio frequency integrated circuit is a receiver while in another it is a transceiver. As a transceiver, the radio frequency integrated circuit further includes an input receiver to receive a serial digital transmission bit stream with a reduced output voltage swing, a data recoverer coupled to the input receiver, a low pass filter coupled to the data recoverer, a mixer coupled to the low pass filter, and an amplifier coupled to the mixer. The input receiver receives a serial digital transmission bit stream with a reduced output voltage swing, and increases the output voltage swing of the serial digital transmission bit stream in the transceiver integrated circuit. The data recoverer recovers the serial digital transmission bit stream from the increased output voltage swing signal. The low pass filter converts the serial digital transmission bit stream into an analog transmission signal. The mixer up-converts the analog transmission signal from a baseband frequency to a second selectable carrier frequency as a transmit radio frequency signal. The amplifier amplifies the transmit radio frequency signal for broadcast over the antenna. The first selected carrier frequency and the second selected carrier frequency are selected from a set of carrier frequencies of selected wireless communication systems.

In another embodiment of the invention, a radio frequency integrated circuit includes an input receiver, a data recoverer coupled to the input receiver, a low pass filter coupled to the data recoverer, a mixer coupled to the low pass filter, and an amplifier coupled to the mixer. The input receiver receive a serial digital transmission bit stream with a reduced output voltage swing and increases the output voltage swing of the serial digital transmission bit stream in the radio frequency integrated circuit. The data recoverer recovers the serial digital transmission bit stream from the increased output voltage swing signal. The low pass filter converts the serial digital transmission bit stream into an analog transmission signal. The mixer up converts the analog transmission signal from a baseband frequency to a selected carrier frequency as a transmit radio frequency signal. The amplifier amplifies the transmit radio frequency signal for broadcast over an antenna. In one embodiment, the radio frequency integrated circuit is a transmitter while in another it is a transceiver.

In another embodiment, a method for a wireless radio is disclosed. The method includes receiving a wireless radio signal; down-converting the wireless radio signal to strip away the carrier signal from a first analog signal; converting the first analog signal into a first serial digital data signal; reducing the output voltage swing in the first serial digital data signal; and transmitting the first serial digital data signal with the reduced output voltage swing from a radio integrated circuit to a digital signal processing (DSP) integrated circuit.

In yet another embodiment the method further includes receiving the first serial digital data signal with the reduced output voltage swing; increasing the output voltage swing in the first serial digital data signal; reducing the sampling frequency of the first serial digital data signal; and converting the first serial digital data signal into a parallel digital data signal for processing by the DSP integrated circuit. The converting of the first analog signal into the first serial digital data signal uses a delta-sigma modulation. The converting of the first serial digital data signal into the parallel digital data signal is a delta-sigma demodulation of the first serial digital data signal into the parallel digital data signal. The transmitting of the first serial digital data signal is over a single wire in one embodiment and in another embodiment, the transmitting of the first serial digital data signal is over a pair of wires; the first serial digital data signal is transmitted over the pair of wires as a differential data signal. The method further includes receiving a second serial digital data signal with a reduced output voltage swing from the DSP integrated circuit; increasing the output voltage swing in the second serial digital data signal; converting the second serial digital data signal into a second analog signal; up-converting the second analog signal to a selectable carrier frequency; and transmitting the second analog signal over an antenna as a radio frequency signal.

### BRIEF DESCRIPTION OF THE DRAWINGS

FIG. 1 is block diagram of an exemplary wireless communication system employing the invention.

FIG. 2A is block diagram of a wireless mobile radio unit, such as a mobile cellular telephone.

FIG. 2B is block diagram of a wireless stationary radio unit, such as a cellular telephone base station.

FIG. 3A is a block diagram of a system including a radio receiver integrated circuit (IC), a radio transmitter IC, and a baseband digital signal processing (DSP) IC.

FIG. 3B is a magnified block diagram of the radio receiver integrated circuit (IC).

FIG. 3C is a magnified block diagram of the radio transmitter integrated circuit (IC).

FIG. 3D is a magnified block diagram of the baseband digital signal processing (DSP) integrated circuit (IC).

FIG. 4 is a block diagram of an alternate embodiment of the system including a radio receiver integrated circuit (IC), a radio transmitter IC, and a baseband digital signal processing (DSP) IC.

FIG. 5 is a block diagram of another alternate embodiment of the system including a radio receiver integrated circuit (IC), a radio transmitter IC, and a baseband digital signal processing (DSP) IC.

FIG. 6A is a block diagram of a system including a radio transceiver integrated circuit (IC), and a baseband digital signal processing (DSP) IC.

FIG. 6B is a magnified block diagram of the radio transceiver integrated circuit (IC).

FIG. 6C is a magnified block diagram of the baseband digital signal processing (DSP) integrated circuit (IC).

FIG. 7 is a block diagram of an alternate embodiment of the system including a radio transceiver integrated circuit (IC) and a baseband digital signal processing (DSP) IC.

FIG. 8 is a block diagram of another alternate embodiment of the system including a radio transceiver integrated circuit (IC) and a baseband digital signal processing (DSP) IC.

FIG. 9A is a block diagram to illustrate details of a receive channel of a digital interface between a radio integrated circuit (IC) and a baseband digital signal processing (DSP) IC.

FIG. 9B is a block diagram to illustrate an alternate embodiment of clock generation and synchronization for the digital serial interface between a radio integrated circuit (IC) and a baseband digital signal processing (DSP) IC.

FIG. 10 is a graph illustrating a simulation of interference level of the digital interface in comparison to frequency bands of communication systems, data spectrum, and the clock spectrum.

### DETAILED DESCRIPTION OF THE PREFERRED EMBODIMENTS

In the following detailed description of embodiments of the invention, numerous specific details are set forth in order to provide a thorough understanding. However, one skilled in the art would recognize that the embodiments of the invention may be practiced without these specific details. In other instances well known methods, procedures, components, and circuits have not been described in detail so as not to unnecessarily obscure aspects of the embodiments of the invention.

The embodiments of the invention include methods, apparatuses and systems for radio frequency integrated circuits and digital signal processing integrated circuits. The embodiments of the invention provide a new and optimized way to exchange received radio signals between a radio receiver integrated circuit and a digital processing circuit. The embodiments of the invention further provide new ways to exchange signals for transmission between a radio transmitter integrated circuit and a digital processing circuit.

The embodiments of the invention are particularly applicable to cellular phones but may be also used in other types of radios. The embodiments of the invention simplify the physical interface (e.g., reduces the number of pins and thereby eases printed circuit board design), simplify the control layers (by providing a high dynamic range), enables multi-standard operation through software changes (flexible in that band changes, code changes, filter changes, mode changes, etc. can be made by software control), lowers costs, and conserves power.

The embodiments of the invention use a combination of analog to digital conversion, digital coding, high-speed digital interface and digital filtering to achieve transfer of information between two integrated circuits (ICs) over a serial digital bit stream. Received radio signals are converted to a digital format within the radio frequency IC. The digital format of the received radio signals are communicated to a digital processing IC over the high speed digital interface by means of the serial digital bit stream. The digital processing IC performs digital filtering and does no analog processing of the radio signal. The digital processing IC avoids costly analog processing blocks and therefore can be manufactured in lower cost digital manufacturing processes.

In one embodiment, the digital interface includes an analog to digital converter built as a sigma delta modulator with a single bit digital stream output, a low voltage differential signal transmitter, a matched differential line to provide a physical connection, and a low voltage differential signal receiver with subsequent digital data recovery and signal processing. The configuration of elements with the high speed digital interface between the radio IC and the digital processing IC enables high dynamic range signals to be transferred to the digital IC where they can be digitally filtered.

That is, the digital format chosen supports multiple data transfer rates, and thus applies to many different radio protocols, in particular it spans from narrow to wide band radio systems, and for example can be used for cellular phones from first generation to the latest wide band third generation standards. It also supports very high data rates, up to hundreds of mega-bits per second, and thus is suitable for transfer of softly filtered radio signals, which have a high dynamic range, requiring higher over-sampled data rates.

To support the digital interface, modulators/decimators are utilized. Multiple modulation/demodulation standards may be used including sigma-delta modulation/demodulation, also referred to as delta-sigma modulation/demodulation. In a preferred embodiment, the encoding of the signal is realized using a multi rate sigma-delta modulator with two levels of quantization, a single bit modulator, to generate a digital bit serial data stream.

The digital format being a low voltage differential signal and the coding generating a single digital bit serial data stream inherently provides low spurious radio emissions, which is important in any radio receiver. Moreover, a data rate clock does not need to be explicitly transmitted with the signal of the single digital bit serial data stream, thereby eliminating another source of spurious emission.

The digital format and coding chosen does not require the formatting of the information into parallel words and therefore there is no need for handshake synchronization to realize data transfer. Transferring data in parallel consumes power due to the output drivers having to drive high capacitive loads. Transferring data serially lowers current/power consumption. Moreover, fewer lines change state between integrated circuits, reducing another source of radio spurious emissions. Eliminating handshake synchronization signals also eliminates another source of radio spurious emissions and current/power consumption. Moreover, the number of pins used for the integrated circuit is reduced when serially transmitting data and avoiding the use of hand shake synchronization signals.

At a physical level, the digital interface uses low voltage differential signaling to provide low current/power consumption, high-speed data transfer, and low spurious emissions.

The digital interface optimizes power consumption within the complete radio transceiver system as it minimizes digital signal processing performed by radio frequency analog integrated circuits and minimizes analog signal processing performed by the digital signal processing integrated circuits. The radio frequency analog integrated circuits, which transceive the analog signals with an antenna, use Silicon manufacturing techniques optimized for analog processing. Silicon manufacturing techniques optimized for analog signal processing often have lower performance when used for digital signal processing, in comparison with Silicon manufacturing processes optimized for digital signal processing. Similarly, Silicon manufacturing techniques optimized for digital signal processing often have lower performance when used for analog signal processing, in comparison with Silicon manufacturing processes optimized for analog signal processing. The use of the disclosed digital interface between the RF analog integrated circuits and the baseband DSP integrated circuit, suppresses a need to perform analog signal processing in the baseband DSP integrated circuit and digital signal processing in the RF analog integrated circuits, easing their design and manufacture. Complex mixed signal circuits are avoided by employing the disclosed digital interface between the RF analog integrated circuits and the baseband DSP integrated circuit. The digital interface is provided to optimize the overall design and manufacture of the radio transceiver.

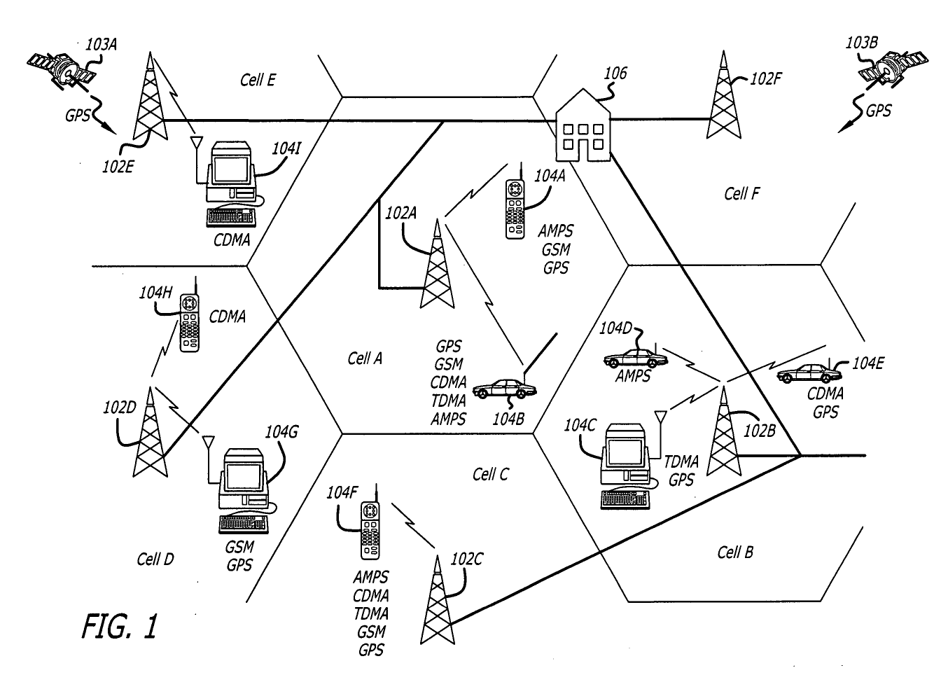

Referring now to FIG. 1, a block diagram of an exemplary wireless communication system is illustrated. The cellular communication system includes base stations 102A-102F, mobile devices or units 104A-104I and a switching center 106. Satellites 103A-103B may also be apart of the cellular communication system. The mobile devices or units 104A-104I may be cellular telephones, personal digital assistants, or portable computers, for example. The base stations 102A-102F and their one or more antennas form cell boundaries of cells A-F. The base stations 102A-102F may couple to the switching center 106 through intercellular trunk lines. The intercellular trunk lines may be fiber optic cables, wire cables, or microwave relay lines.

The cellular communication system illustrated in FIG. 1 is a multimode wireless communication system. One or more of the mobile devices may use differing methods of wireless communication with the base stations. That is, the radio frequency and modulation/demodulation at the physical link layer and the type of digital coding used at the data link layer may be different depending upon the type of wireless communication mode selected. For example, one or more communication systems with differing frequency bands, modulation, and channel coding may be used such as Universal Mobile Telecommunication System (UMTS), Global System for Multiple Communication (GSM), GSM Mobile Application Part (GSM-MAP), General Packet Radio Protocol System or General Packet Radio Service (GPRS), Enhanced Data GSM Environment (EDGE), (GAIT), Orthogonal Frequency-Division Multiplexing (OFDM), Code Orthogonal Frequency Division Multiplexing (COFDM), Block Coding, Convolutional Coding, Turbo Coding, Trellis Coding, Gaussian Minimum Shift Keying (GMSK), Quadrature Phase Shift Keying (QPSK), Quadrature Amplitude Modulation (QAM), Frequency Modulation (FM), Frequency Division Multiple Access (FDMA), Time Division Multiple Access (TDMA), Code Division Multiple Access (CDMA), Narrowband CDMA (N-CDMA), Wideband CDMA (W-CDMA), CDMA2000, CDMA2000-1XEV, CDMA2000-EVDO, CDMA2000-EDV, Time Division-Synchronized Code Division Multiple Access (TD-SCDMA), Third-Generation Partnership Project (3GPP TDD), International Mobile Telecommunication (IMT), IMT2000MC, IMT2000DS, IMT2000SC, IMT2000TC, Personal Communication System (PCS), Digital Communication System (DCS), Personal Digital Cellular (PDC), Digital Enhanced Cordless Telecommunications (DECT), Advanced Mobile Phone System (AMPS), Wireless Local Area Network (LAN) (IEEE 802.11a, IEEE 802.11b, IEEE 802.11g), and Global Positioning System (GPS) wireless communication systems. The base stations and mobile devices may support one or more of these as multimode (and/or multislot, multiband, multicode, multisystem) devices.

Consider the mobile devices 104H and 104G in cell D, for example. Wireless device 104H may wirelessly communicate with the base station 102D using a CDMA communication link while wireless device 104G may communicate with the base station 102D using a GSM communication link. As another example, consider wireless device 104F in cell C. The wireless device 104F is a multimode communication device and may communicate with the base station 102C using one or more types of wireless communication links such as AMPS, CDMA, TDMA, or GMS. The wireless device 104F may also communicate with the satellites 103A-103B using a GPS frequency band. As yet another example, consider wireless devices 104A and 104B in cell A. Wireless device 104A may communicate with the base station 102A using AMPS or GSM. The wireless device 104A may also communicate with the satellites 103A-103B using a GPS frequency band. Wireless device 104B may communicate with the base station 102A using one or more types of wireless communication links such as AMPS, CDMA, TDMA, or GMS. The wireless device 104A may also communicate with the satellites 103A-103B using a GPS frequency band. In this manner, the base stations may be shared by the differing communication links.

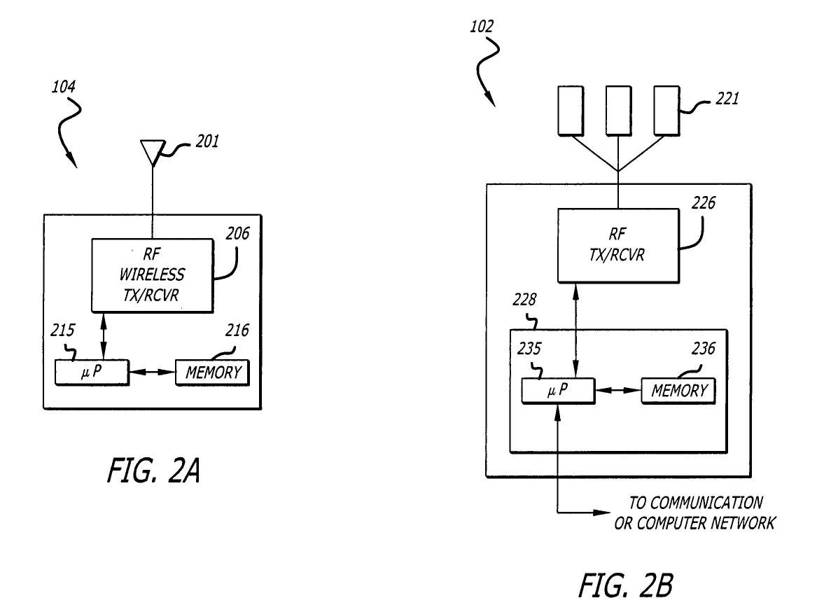

Referring now to FIG. 2A, a block diagram of a wireless mobile radio unit 104, such as a mobile cellular telephone, is illustrated. The wireless mobile radio unit 104 supports multicode, multislot, multimode, multiband, multisystem, and/or differing types of wireless communication modes. The wireless mobile radio unit 104 may be utilized in the multimode cellular communication system described previously with respect to FIG. 1 as well as the other different communication systems previously described.

The wireless mobile radio unit 104 includes an antenna 201, a radio frequency receiver/transmitter or transceiver 206, a microprocessor 215 and a memory 216. The radio frequency transceiver 206 is coupled to the antenna 201 to transmit and receive radio waves. The radio frequency transceiver 206 is a unified hardware component that can support multiple types of wireless communication systems and the multibands, multislots, multicodes, and multimodes, such as CDMA, GSM, TDMA, etc. The radio frequency transceiver 206 couples to the microprocessor 215 for bidirectionally communicating data therewith. The microprocessor 215 is coupled to the memory 216 to read instructions for execution and to read and write data therewith. Software code may be stored in the memory 216 or other storage device of the wireless mobile radio unit 104 for execution by the microprocessor 215. As will be discussed further below, the software code may be used to support the various types of wireless communication modes and systems.

Referring now to FIG. 2B, a block diagram of a wireless stationary radio unit 102, such as a cellular telephone base station, is illustrated. The base station 102 supports multicode, multislot, multimode, multiband, multisystem, and/or differing types of wireless communication modes. Base station 102 may be utilized to support the multimode cellular communication system described previously with respect to FIG. 1.

In base station 102, a radio frequency transmitter/receiver or transceiver 226 is provided coupled to the antenna 221. The radio frequency transceiver 226 is a unified hardware component that can support multiple types of wireless communication systems and the multibands, multislots, multicodes, and multimodes, such as CDMA, GSM, TDMA, etc. The radio frequency transceiver 226 couples to a microprocessor 235 of a computer 228 for bidirectionally communicating data therewith.

The computer 228 includes the microprocessor 235 and a memory 236. Software code may be stored in the memory 236 or other storage device (e.g., hard disk) of the computer for execution by the microprocessor 235. As will be discussed further below, the software code may be used to support the various types of wireless communication modes and systems.

The computer 228 and microprocessor 235 therein may externally couple to a communication network or computer network depending upon the type of system where it is utilized. The communication network may be a cellular telephone communication system with a connection to the plain old telephone system (POTS). The computer network may be a wireless local area network for example with a connection to the Internet.

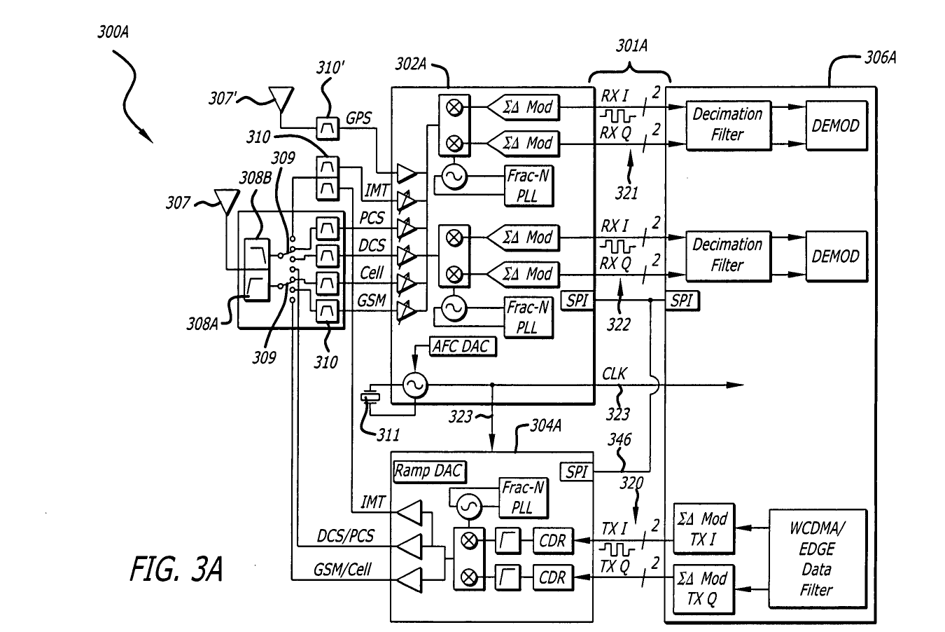

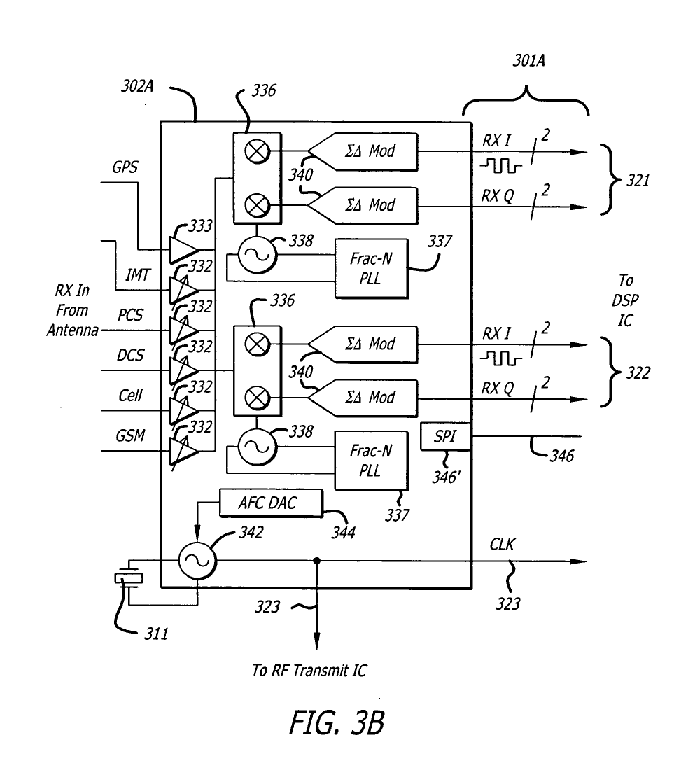

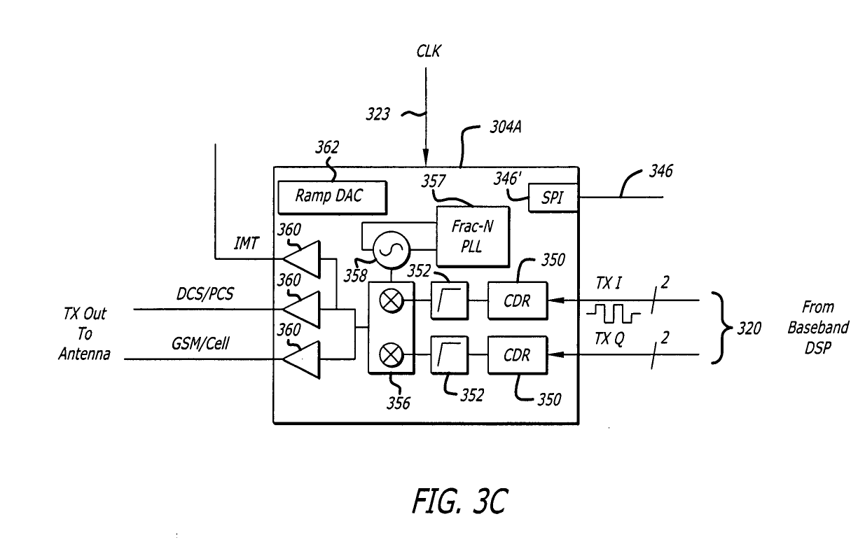

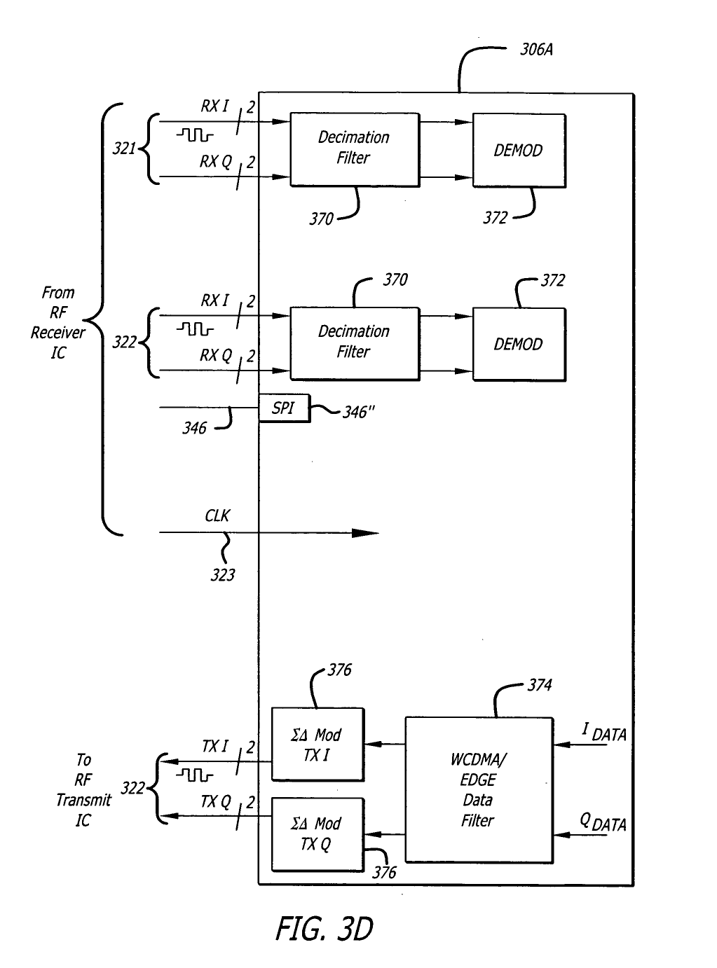

FIGS. 3A, 4, 5, 6A, 7, and 8 illustrate alternate embodiments for the radio frequency transceiver 206 of the wireless mobile radio unit 104 and the radio frequency transceiver 226 of the base station 102 coupled to the antenna.

Referring momentarily now to FIGS. 3A and 4-5, separate receiver radio chips, transmitter radio chips are illustrated coupled to a baseband digital signal processing chip. With greater integration and lower power, the separate receiver radio chips and transmitter radio chips may be integrated together into a transceiver radio chip. Additionally, the baseband digital signal processing chip may be one or more digital signal processor integrated circuits or a programmable general purpose processor, such as a microprocessor, with program instructions to provide digital signal processing.

Referring now to FIG. 3A, an embodiment of the invention is illustrated. FIG. 3A illustrates a system 300A including a radio receiver integrated circuit (IC) 302A, a radio transmitter IC 304A, and a baseband digital signal processing (DSP) IC 306A coupled together as shown to support multiple wireless communication system, sometimes referred to as multimode.

The system 300A further includes a duplex antenna 307, a GPS receiving antenna 307′, a low pass receive passive filter 308B coupled between the antenna 307 and a duplexer switch 309, a high pass transmit passive filter 308A coupled between the antenna 307 and the duplexer switch 309, a GPS band-pass passive filter 310′ coupled between the antenna 307′ and a low noise amplifier of the radio receiver IC 302A, a plurality of band-pass passive filters 310 coupled between the duplexer switch 309 and one or more programmable gain low noise amplifiers of the radio receiver IC 302A, one band-pass passive filter 310 coupled between the duplexer switch 309 and a power amplifier of the radio transmit IC 304A, and the duplexer switch 309 coupled between the filter 308A,308B at one pole and filters 310 and power amplifiers at another pole, as illustrated and coupled together as shown in FIG. 3A.

The system 300 A may further include a quartz crystal 311 coupled to a clock generator of the radio receiver IC 302A. A reference clock signal, Clock 323, generated by the clock generator may be coupled from the radio receiver IC 302A into the baseband DSP IC 306A and the radio transmitter IC 304A. The reference clock signal is a reference clock that is used to generate high speed local clock signals within the baseband DSP IC 306A and the radio transmitter IC 304A. The reference clock signal may be varied for the system to adapt to various wireless communication systems with different carrier frequencies and various data communication rates. The reference clock signal, Clock 323, is a lower level frequency than that of the internal local clocks within the baseband DSP IC 306A and the radio transmitter IC 304A in order to reduce noise generated by an external or off-chip clock signal.

A serial control bus 324 may also couple from the baseband DSP IC 306A into the radio receiver IC 302A and the radio transmitter IC 304A to control the selection frequencies and tailor the RF integrated circuits for the wireless communication channels of the selected wireless communication systems.

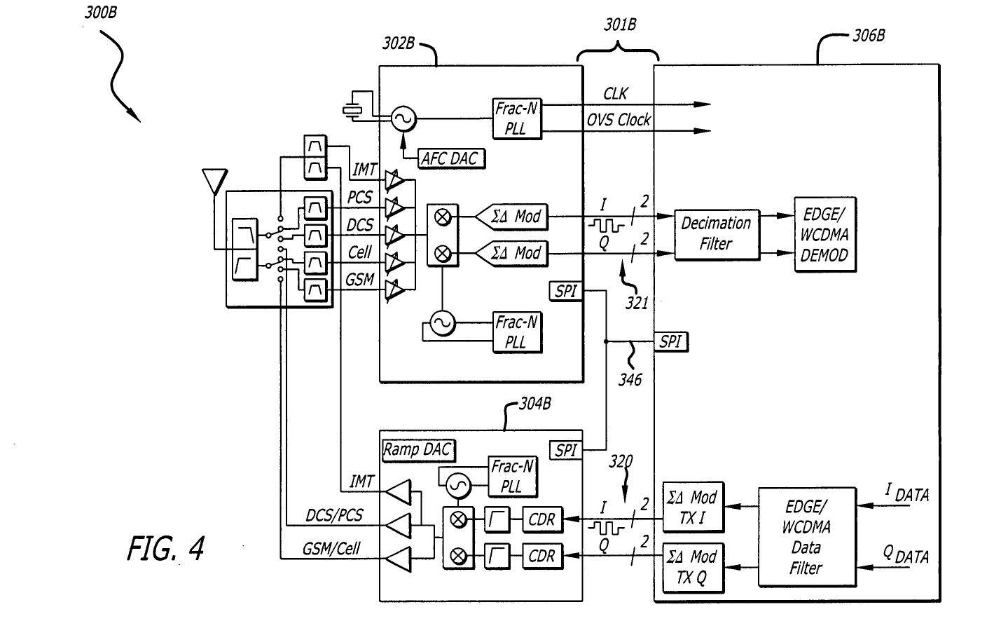

The embodiments of the systems illustrated in FIGS. 4-6A, and 7-8 may have similar passive filters 308A, 308B, 310, 310′; duplexer switches 309; and one or more antennas 307,307′ coupled together with slight variations to support chosen wireless communication systems. As these details are not pertinent to the invention, they are not described in further detail below, but are illustrated in the Figures.

The system 300A illustrated in FIG. 3A can support five wireless communication systems (i.e., pentaband) including Universal Mobile Telecommunication System (UMTS), Global System for Multiple Communication (GSM), General Packet Radio Protocol System (GPRS), Enhanced Data GSM Environment (EDGE), and Global Positioning System (GPS) wireless communication systems. An alternate embodiment from that illustrated in FIG. 3 eliminates the GPS receiver. In another alternate embodiment, GSM, GPRS, and EDGE are not supported as one of the communication systems of the multimode communication systems and thus, the extra circuitry and connections to support GSM, GPRS, and EDGE are not required.

The radio receiver integrated circuit (IC) 302A receives analog radio frequency signals, performs analog signal processing, and converts them into one or more serial digital bit streams in a low voltage differential signal format to be coupled into the baseband DSP IC 306A.

The baseband digital signal processing (DSP) IC 306A digitally processes the one or more serial digital bit streams in the low voltage differential signal format and performs digital filtering to extract the received digital data from the wireless communication link. For transmission, the baseband digital signal processing (DSP) IC 306A accepts digital data that is to be transmitted and pre-distorts the transmit digital data using digital filtering, responsive to what communication link the data is being transmitted, and generates one or more serial digital bit streams in the low voltage differential signal format for communication to the radio transmitter IC 304A.

The radio transmitter IC 304A receives the one or more serial digital bit streams in the low voltage differential signal format representing the data that is to be transmitted. The radio transmitter IC 304A converts the one or more serial digital bit streams in the low voltage differential signal format into analog signals, performs analog signal processing, and amplifies the analog signals for transmission and broadcast out over the antenna.

The interface between radio integrated circuits (e.g., the radio receiver IC 302A and the radio transmitter IC 304A) and the baseband digital signal processing (DSP) IC in the invention is a digital interface. Typical mixed signal circuitry employed between radio ICs and the baseband DSP IC has been eliminated by the invention. Typically a mixed signal codec IC was employed as the mixed signal interface or mixed signal codec circuitry was placed on the DSP IC. A new digital interface, one aspect of the invention, is employed between the radio ICs and the baseband DSP IC to eliminate the mixed signal interface. The invention reduces system cost by eliminating the mixed signal interface. Analog circuitry is not needed between or on the baseband DSP IC. Without analog circuitry on the baseband DSP IC, faster migration of the baseband DSP IC to circuits with smaller process manufacturing technologies can be had further reducing costs of the baseband DSP IC. Moreover, the digital interface may use a low voltage differential swing to support high-speed data transfer between the radio frequency ICs and the baseband DSP IC.

As one aspect of the invention, the system 300A includes a digital interface 301A between the radio integrated circuits (e.g., the radio receiver IC 302A and the radio transmitter IC 304A) and the baseband digital signal processing (DSP) IC 306A. The digital interface 301A in the system 300A of FIG. 3A is one or more receive channels 321-322 and one or more transmit channels 320. Each channel is a digital serial bit stream. A parallel digital word is not employed in order to reduce a large number of I/O traces that otherwise would be needed. The digital serial bit interface reduces the noise that would otherwise be generated by parallel data bus traces that may otherwise interfere with radio frequency signals. A digital serial bit interface further eliminates any noise sensitive analog traces that otherwise might have been used between radio ICs and the baseband DSP IC.

Each channel may communicate using a low voltage swing differential signal, in which case two wire traces are used for each. The one or more receive channels 321 and 322 each include an RX I channel and an RX Q channel for complex data including imaginary and real terms. In an alternate embodiment, the RX I channel and a RX Q channel may be interleaved into one RX channel. The one or more transmit channels 320 include a TX I channel and a TX Q channel for complex data signals including imaginary and real terms (e.g., S=Q+Ij). In an alternate embodiment, the TX I channel and a TX Q channel may be interleaved into one TX channel. In yet another embodiment, the RX Q channel and RX I channel are magnitude data and phase data of a multiphase signal S, where S=Qe^{jI}. These are also sometimes referred to as polar coordinates.

Referring now to FIG. 3B, a magnified block diagram of the radio frequency receiver integrated circuit 302A is illustrated. The radio frequency receiver integrated circuit 302A, includes one or more programmable gain low noise amplifiers 332, a constant gain low noise amplifier 333, one or more pairs of mixers 336 also referred to as down converters, one or more programmable phase locked loops (Frac-N PLL) 337, one or more local oscillators 338, one or more pairs of sigma-delta modulators (ΣΔ Mod) 340, a frequency controlled clock generator 342, an automatic frequency control digital to analog converter (AFC DAC) 344, and a serial peripheral interface (SPI) 346 coupled together as shown and illustrated in FIG. 3B.

The one or more programmable gain low noise amplifiers 332 receive the analog radio frequency signals from various wireless communication systems. The constant gain low noise amplifier 333 receives analog radio frequency signals broadcast from GPS satellites.

The one or more pairs of mixers 336 couple to outputs of the amplifiers 332,333 and down convert the analog radio frequency signals into an intermediate or baseband frequency analog signal and generate the in-phase or real (I) component and the quadrature phase or imaginary (Q) component of the analog signal. The one or more programmable phase locked loops (Frac-N PLL) 337 couple to and control the one or more local oscillators 338. The one or more local oscillators 338 selectively generate a carrier frequency signal for a given system that is coupled into the one or more pairs of mixers 336. It is this carrier frequency signal that is used to strip away the carrier frequency from the analog radio frequency signals.

The one or more pairs of sigma-delta modulators (ΣΔ Mod) 340 are coupled respectively to the I and Q component outputs of the one or more pairs of mixers 336 to receive the analog I and Q signals. The one or more pairs of sigma-delta modulators (ΣΔ Mod) 340 quantize and convert the I and Q analog signals into I and Q serial digital bit signals.

In another embodiment, the sigma-delta modulators may be delta modulators. In yet another embodiment, the sigma-delta modulators may be modulating analog-to-digital converters with a single digital bit output to provide a serial bit stream (e.g., an analog-to-digital converter combined with a modulator having a single bit output). In any case, the modulators are a type of modulator that receive an analog input signal and have a single bit output to provide a serial digital data stream. Collectively, the various types of modulators may be referred to herein as single bit modulators or modulating analog-to-digital converters with a single bit output.

The I and Q serial digital bit signals are then coupled into a pair of low differential voltage output drivers (not shown in FIG. 3B) to generate a differential signal with a low voltage swing to speed data transfer external to the chip and lower noise generation.

The automatic frequency control digital to analog converter (AFC DAC) 344 is coupled to and controls the frequency controlled clock generator 342. The external quartz crystal 311 couples into the oscillator inputs of the frequency controlled clock generator 342. The clock output of the frequency controlled clock generator 342 may be coupled to the one or more pairs of sigma-delta modulators (ΣΔ Mod) 340 and may also externally couple to the baseband DSP IC 306A.

The serial peripheral interface (SPI) receiver 346′ may be used to communicate control information serially between integrated circuits of the system 300A. In particular, the baseband DSP IC 306A communicates control information, such as the frequencies, modulation/demodulation, and encoding/decoding for the selected communication channels and systems. The (SPI) bus 346 is a serial data bus.

Referring now to FIG. 3C, a magnified block diagram of the radio frequency transmit integrated circuit 304A is illustrated. The radio frequency transmit integrated circuit 304A includes a pair of data recoverers 350 (also referred to as “data recovery circuit or data recovery functional block”, CDR), a pair of low pass analog filters 352, a pair of mixers 356 also referred to as up-converters, one or more power amplifiers 360, a programmable phase locked loop (Frac-N PLL) 357, a local oscillator 358, a Ramp digital to analog converter (Ramp DAC) 362, and a serial peripheral interface (SPI) 346 coupled together as shown and illustrated in FIG. 3C.

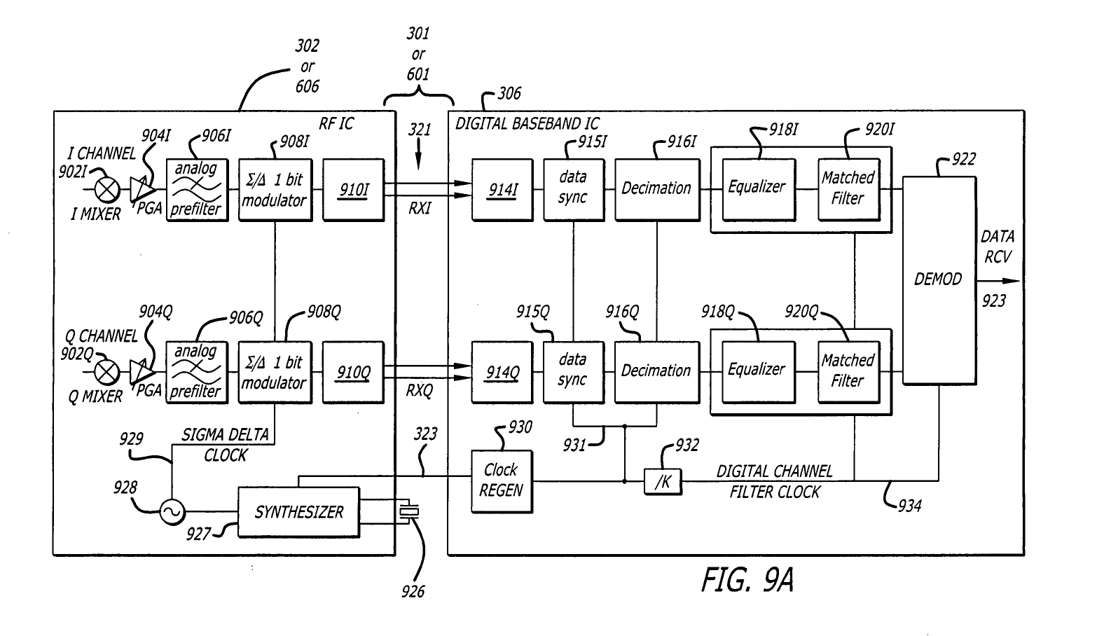

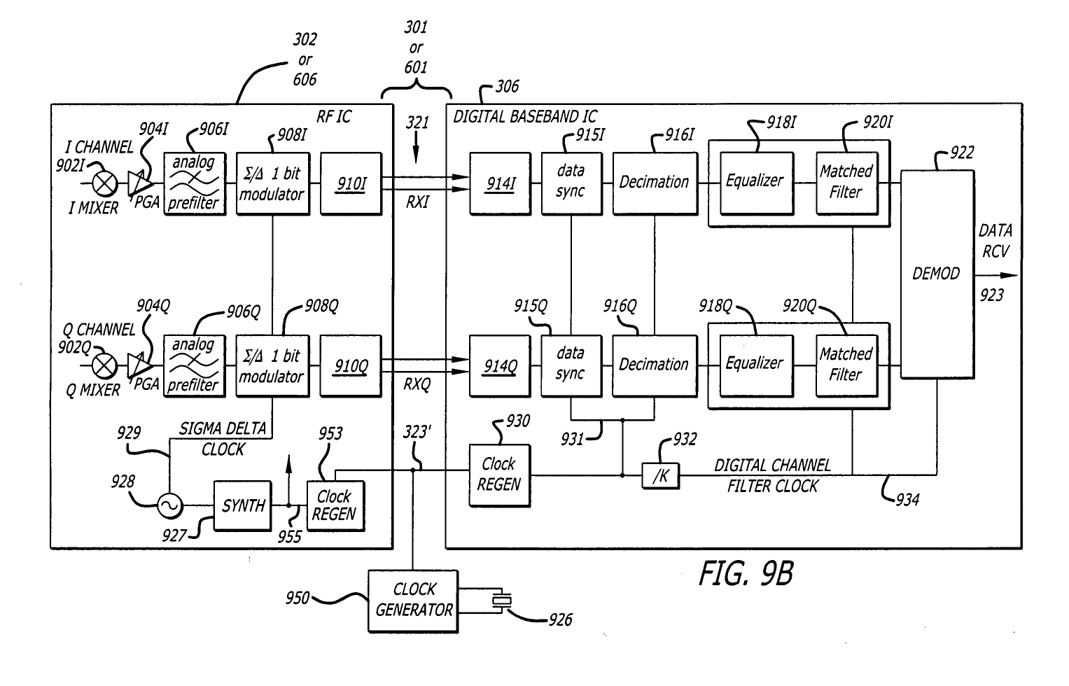

The radio frequency transmit integrated circuit 304A further includes a pair of low voltage differential input receivers (not shown in FIG. 3A, see differential input receivers 914I and 914Q illustrated in FIG. 9A) to receive the low voltage differential digital bit stream of the I and Q channels from the baseband DSP 306A and convert them into a single ended high voltage swing digital bit stream of the I and Q channels on chip.

The pair of data recoverers 350 (also referred to as “data recovery circuit or data recovery functional block”, CDR) receive single ended high voltage swing digital bit stream of the I and Q channels and recover the digital data stream of the I and Q channels. The digital data stream of the I and Q channels are coupled into the pair of low pass analog filters 352 to generate I and Q analog signals for transmission.

The pair of analog filters 352 filter out high frequency noise and generate an analog output signal from the serial bit steam of data. The I and Q analog signals are generated by the low pass filters 352 at a baseband frequency and are coupled into the pair of mixers 356.

The pair of mixers 356 receive the I and Q analog signals at a baseband frequency and up-converter them to the desired carrier frequency for transmission over a given wireless communication system. The carrier frequency is selected by using the programmable phase locked loop (Frac-N PLL) 357 to drive the local oscillator 358. The local oscillator 358, having a selectable carrier frequency, has its oscillation output coupled to one of the inputs of the pair of mixers 356. The pair of mixers 356 combines the I and Q analog signals at the carrier frequencies into a single radio frequency analog signal which is coupled into the one or more power amplifiers 360.

The one or more power amplifiers 360 receive the radio frequency analog signal and amplify it into a radio frequency analog output signal with increased power output that is coupled into the antenna for radiating. The digital interface allowed the one or more power amplifiers 360 to be integrated as part of the transmitter IC 304A because other analog circuitry was eliminated (e.g., the parallel ADC and active analog filters) and power was conserved. The integration of the power amplifier with the transmitter eliminates other circuitry such as isolators and power detectors. The integration of the power amplifier with the transmitter also enables predistortion of transmit signals, in a closed or open loop fashion, and therefore can improve transmitter performance.

The Ramp digital to analog converter (Ramp DAC) 362 is for gently ramping or increasing the power of the one or more power amplifiers 360. It may be used to meet time masking and other special masking requirements.

The serial peripheral interface (SPI) receiver 346′ may be used to communicate control information serially between integrated circuits of the system 300A. In particular, the baseband DSP IC 306A communicates control information, such as the frequencies, modulation/demodulation, and encoding/decoding for the selected communication channels and systems. The (SPI) bus 346 is a serial data bus.

Referring now to FIG. 3D, a magnified block diagram of the baseband DSP integrated circuit 306A is illustrated. The baseband DSP integrated circuit 306A includes one or more pairs of low voltage differential input receivers (not shown), one or more decimators/filters 370, one or more data demodulators 372, a pair of data modulators/filters 374, a pair of sigma-delta modulators (ΣΔ Mod) 376, a pair of low voltage differential output drivers (not shown) and a serial peripheral interface (SPI) transmitter 346″ coupled together as shown and illustrated in FIG. 3D.

The one or more pairs of low voltage differential input receivers (not shown) receive the low voltage differential digital bit stream of the I and Q channels from the RF receiver IC 302A and convert them into a single ended high voltage swing digital bit stream of the I and Q channels on chip. There may be one or more pairs used in order to simultaneously support communication over more than one wireless communication system. That is, two channels of communication may be supported. For example, GPS data signals may be received over one communication system such as for navigation or positioning while CDMA voice signals may be simultaneously received over another communication system for wireless cellular telephone calls.

The one or more decimators/filters 370 lower the sampling rate of the I and Q serial bit stream, provide digital filtering, detect data from noise, and convert serial bits into parallel words to generate and received I and Q data words. The function of the one or more decimators/filters 370 is further described below with reference to FIG. 9A.

The one or more data demodulators 372 receives the I and Q data, demodulates the channel modulation, performs further filtering, and converts serial data into parallel data in order to form the received digital data from the wireless communication system. The one or more data demodulators 372 are programmable based on the selected wireless communication system over which data is being received. The function of the one or more data demodulators 372 is further described below with reference to FIG. 9A.

In order to transmit, transmit data is coupled into the pair of data modulators/filters 374. The pair of data modulators/filters 374 provide channel modulation, generating the I and Q components from the transmit data, and digitally prefilter or distort the I and Q digital data components for transmission over the wireless communication system. Depending upon the wireless communication system over which data is being transmitted, the digital data modulator/filter is programmable to select the wireless communication system. The digital data for the I and Q channels is coupled into the pair of sigma-delta modulators (ΣΔ Mod) 376.

The pair of sigma-delta modulators (ΣΔ Mod) 376 are coupled respectively to the I and Q component outputs from the pair of data modulators/filters 374. The pair of sigma-delta modulators (ΣΔ Mod) 376 quantize and convert the I and Q parallel digital signals into I and Q serial digital bit signals. The clock 323 received from the RF receiver IC 302A may be used to clock the one or more pairs of sigma-delta modulators (ΣΔ Mod) 376 to generate the I and Q serial digital bit signals. The I and Q serial digital bit signals are then coupled into the pair of low differential voltage output drivers (not shown).

The pair of low differential voltage output drivers generates a differential signal for each of the I and Q serial digital bit streams with a low voltage swing to speed data transfer external to the chip and lower noise generation. The I and Q serial digital bit streams in a low differential voltage output format is coupled into the RF transmit IC 304A.

Referring now to FIG. 4, another embodiment of the invention is illustrated. FIG. 4 illustrates a system 300B including a radio receiver integrated circuit (IC) 302B, a radio transmitter IC 304B, and a baseband digital signal processing (DSP) IC 306B coupled together as shown to support multiple wireless communication system, sometimes referred to as multimode. FIG. 4 also supports five systems (i.e., pentaband) including a UMTS compressed mode and an EDGE compressed mode system. As described previously with respect to FIG. 3, alternative embodiments may be achieved from that illustrated in FIG. 4 by reducing the number and type of wireless communications systems supported so that combinations of single, dual, triple, and quad bands may be supported instead of the pentaband wireless communications systems illustrated.

As one aspect of the invention, the system 300B includes a digital interface 301B between the radio integrated circuits (e.g., the radio receiver IC 302B and the radio transmitter IC 304B) and the baseband digital signal processing (DSP) IC 306B. The digital interface 301B in the system 300B of FIG. 4 is one or more receive channels 321 and one or more transmit channels 320. Each channel is a digital serial bit stream. Each channel may communicate using a low voltage swing differential signal, in which case two wire traces are used for each. The one or more receive channels 321 include a RX I channel and a RX Q channel for complex data including imaginary and real terms. In an alternate embodiment, the RX I channel and a RX Q channel may be interleaved into one RX channel. The one or more transmit channels 320 include a TX I channel and a TX Q channel for complex data including imaginary and real terms. In an alternate embodiment, the TX I channel and a TX Q channel may be interleaved into one TX channel.

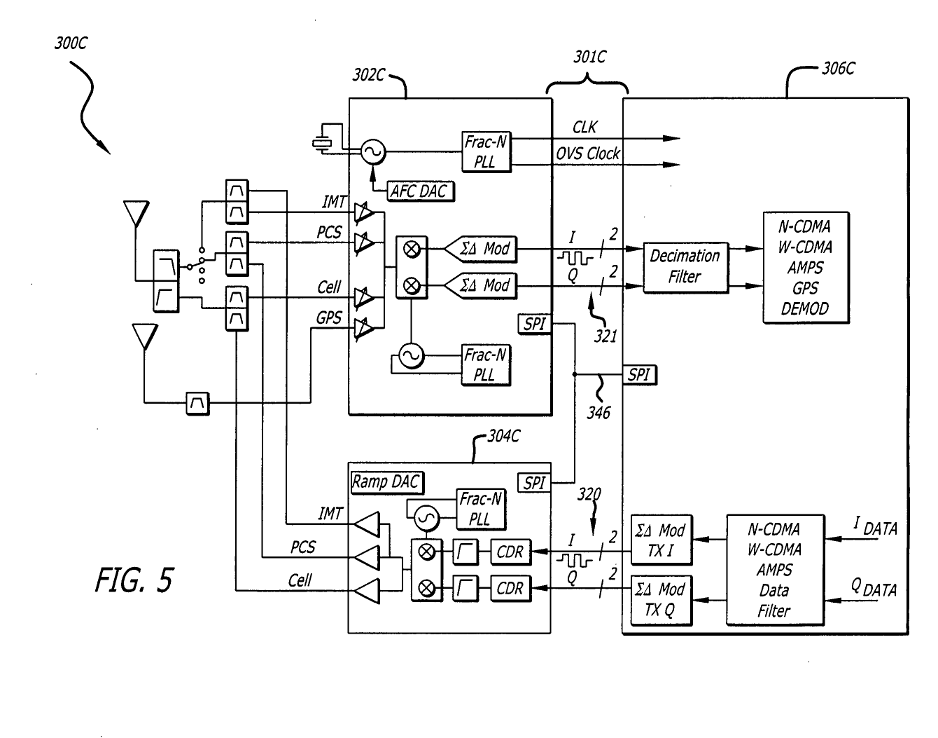

Referring now to FIG. 5, another embodiment of the invention is illustrated. FIG. 5 illustrates a radio receiver integrated circuit (IC) 302C, a radio transmitter IC 304C, and a baseband digital signal processing (DSP) IC 306C coupled together as shown to support multiple wireless communication system, sometimes referred to as multimode. The embodiment of FIG. 5 supports four systems (i.e., quadband) including PCS with an N-CDMA code-division-multiple access wireless communication system. The embodiment of FIG. 5 further supports an IMT with a W-CDMA, AMPS cellular, and GPS. As described previously with respect to FIG. 3, alternative embodiments may be achieved from that illustrated in FIG. 5 by reducing the number and type of wireless communications systems supported so that combinations of single, dual, and triple bands may be supported instead of the quadband wireless communications systems illustrated. That is, the system of FIG. 5 may or may not include support for GPS and W-CDMA functionality.

As one aspect of the invention, the system 300C includes a digital interface 301C between the radio integrated circuits (e.g., the radio receiver IC 302C and the radio transmitter IC 304C) and the baseband digital signal processing (DSP) IC 306C. The digital interface 301C in the system 300C of Figure F is one or more receive channels 321 and one or more transmit channels 320. Each channel is a digital serial bit stream. Each channel may communicate using a low voltage swing differential signal, in which case two wire traces are used for each. The one or more receive channels 321 include a RX I channel and a RX Q channel for complex data including imaginary and real terms. In an alternate embodiment, the RX I channel and a RX Q channel may be interleaved into one RX channel. The one or more transmit channels 320 include a TX I channel and a TX Q channel for complex data including imaginary and real terms. In an alternate embodiment, the TX I channel and a TX Q channel may be interleaved into one TX channel.

The baseband digital signal processing (DSP) IC 306C provides support for the four systems (i.e., quadband) illustrated in FIG. 5, including PCS with an N-CDMA code-division-multiple access wireless communication system. The DSP IC 306C includes a demodulator to selectively demodulate signals from N-CDMA, W-CDMA, AMPS, and GPS wireless communication systems. The DSP IC 306C further includes a data filter to selectively filter signals for transmission over N-CDMA, W-CDMA, AMPS, and GPS wireless communication systems. Because the active channel filtering is performed in the DSP 306C using digital filtering techniques, the filter coefficients can be easily modified and the frequency selected for whatever wireless communication system over which communication is desired. The flexibility provided by the invention enables the use of one or two radio chips and one DSP chip to address multiple communications standards by software selection, referred to as “Software Radio”.

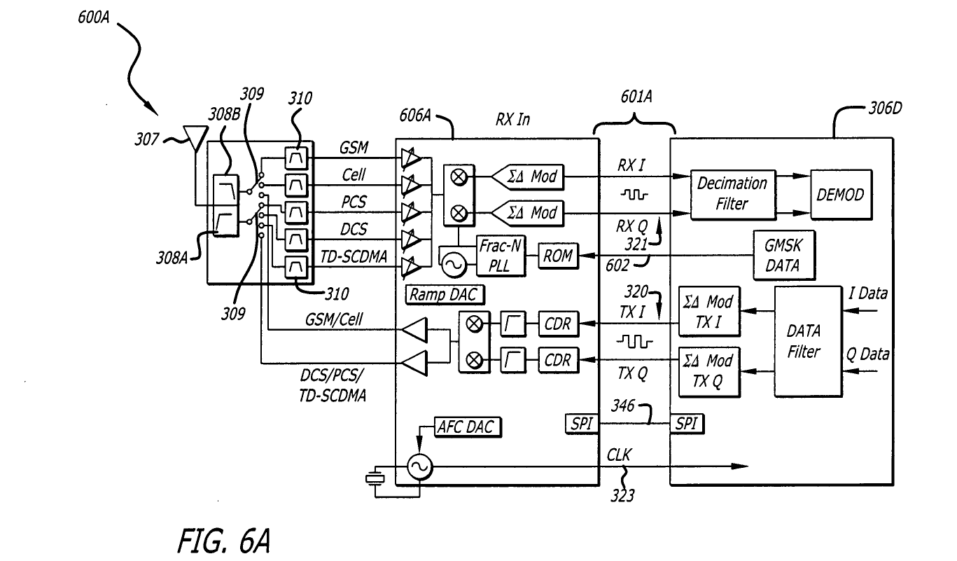

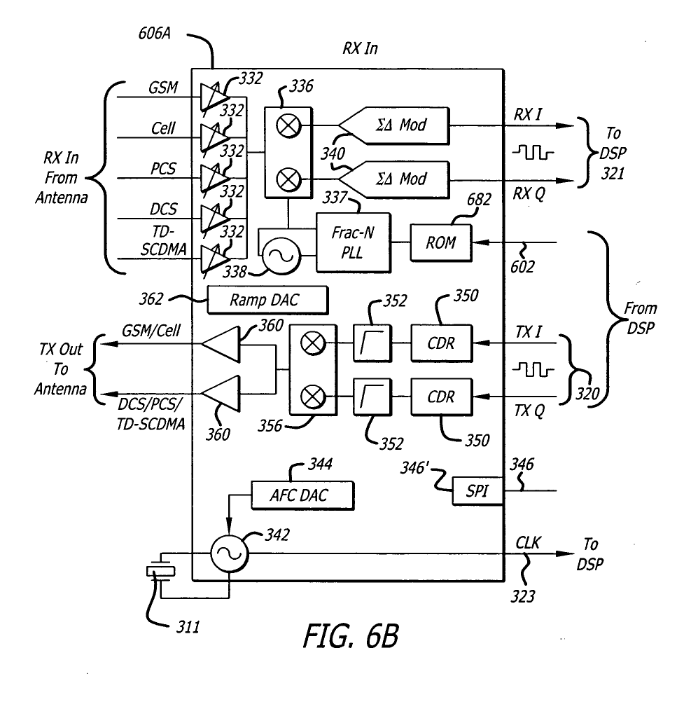

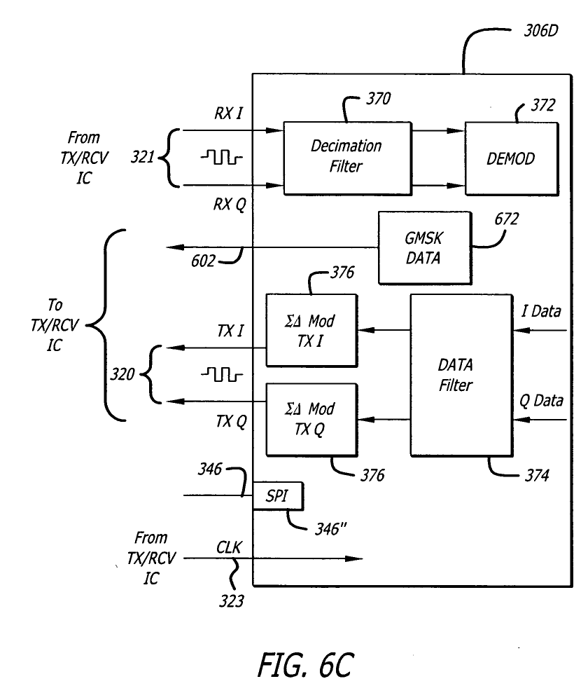

Referring momentarily now to FIGS. 6A and 7-8, integrated transceiver radio chips are illustrated coupled to baseband digital signal processing chips. The integrated transceiver radio chips combine receive and transmit functionality into a single radio frequency integrated circuit.

Referring now to FIG. 6A, another embodiment of the invention is illustrated. FIG. 6A illustrates a system 600A including a radio transceiver integrated circuit (IC) 606A, and a baseband digital signal processing (DSP) IC 306D coupled together as shown to support multiple wireless communication system, sometimes referred to as multimode. The system 600A of FIG. 6A may support up to five wireless communication systems (i.e., pentaband) including a TD-SCDMA system. The system 600A may also be used to support multiple bands of TD-SCDMA systems. Additionally, the system 600A may also be used to support GSM/GPRS/EDGE, AMPS, PCS, and DCS wireless communication systems. In an alternative embodiment, 3GPP TDD may replace TD-SCDMA. Alternative embodiments may also be achieved from that illustrated in FIG. 6A by reducing the number and type of wireless communications systems supported so that combinations of single, dual, triple, and quad bands may be supported instead of the pentaband wireless communications systems illustrated.

As one aspect of the invention, the system 600A includes a digital interface 601A between the radio integrated circuit (e.g., the radio transceiver IC 606A) and the baseband digital signal processing (DSP) IC 306D. The digital interface 601A in the system 600A of FIG. 6A is one or more receive channels 321 and one or more transmit channels 320. Each channel is a digital serial bit stream. Each channel may communicate using a low voltage swing differential signal, in which case two wire traces are used for each. The one or more receive channels 321 include a RX I channel and a RX Q channel for complex data including imaginary and real terms. In an alternate embodiment, the RX I channel and a RX Q channel may be interleaved into one RX channel. The one or more transmit channels 320 include a TX I channel and a TX Q channel for complex data including imaginary and real terms. In an alternate embodiment, the TX I channel and a TX Q channel may be interleaved into one TX channel.

Referring now to FIG. 6B, a block diagram of the radio transceiver integrated circuit 606A is illustrated. The radio transceiver integrated circuits 606B and 606C briefly described below are subsets of the radio transceiver integrated circuit 606A. That is, the radio transceiver integrated circuits 606B and 606C have fewer circuit elements than that of the radio transceiver integrated circuit 606A.

The radio transceiver integrated circuit 606A combines elements of the previously described radio receiver integrated circuit 302A and the radio transmitter integrated circuit 304A into one integrated circuit. An extra receive channel of communication is not used, as GPS signals are not directly received by the radio over a wireless communication link in this case. As elements with the same reference numbers have similar functionality in the radio transceiver integrated circuit 606A and is described previously, the detailed description of the functional blocks is not repeated here for brevity.

The radio frequency transceiver integrated circuit 606A, includes one or more programmable gain low noise amplifiers 332, a pairs of mixers 336 also referred to as down converters, a pair of low voltage differential output drivers (not shown), a programmable phase locked loop (Frac-N PLL) 337, a local oscillator 338, a pair of sigma-delta modulators (ΣΔ Mod) 340, a frequency controlled clock generator 342, an automatic frequency control digital to analog converter (AFC DAC) 344, a serial peripheral interface (SPI) 346, a pair of low voltage differential input receivers (not shown), a data recoverer 350 (also referred to as a data recovery circuit or functional blocks), a pair of low pass analog filters 352, a pair of mixers 356 also referred to as up-converters, one or more power amplifiers 360, a Ramp digital to analog converter (Ramp DAC) 362, and a read only memory (ROM) 682 coupled together as shown and illustrated in FIG. 6B.

The read only memory (ROM) 682 is for constant envelope wireless communication systems (frequency modulation without amplitude modulation) with low data rates, particularly GMSK data modulation. The ROM 682 is a look up table and acts as a waveform generator. Data bits are coupled into the ROM 682 to change the frequency of the constant envelope signal. The ROM 682 couples to a GMSK data modulator of the baseband DSP integrated circuits 306D to receive a data signal. The output of the ROM 682 is coupled to the PLL 337 in order to control the selection of the carrier frequency generated by the local oscillator 338.

Otherwise, the elements with the same reference numbers have similar functionality in the baseband DSP IC 306A and are described previously, the detailed description of the functional blocks is not repeated here for brevity.

Referring now to FIG. 6C, a block diagram of the baseband DSP integrated circuit 306D is illustrated. The baseband DSP integrated circuit 306D is similar to the baseband DSP integrated circuit 306A-306C previously described. The baseband DSP integrated circuits 306E and 306F briefly described below are subsets of the baseband DSP integrated circuit 306D. That is, the baseband DSP integrated circuits 306E and 306F have less functionality than that of the functionality of the baseband DSP integrated circuit 306D. But for the hardware changes for receiving and/or transmitting an extra channel of data over the digital interface, the digital filtering, encoding, decoding, modulation and demodulation of digital data preformed by the baseband DSP integrated circuit may be software programmable from circuit to circuit.

The baseband DSP integrated circuit 306D includes a pair of low voltage differential input receivers (not shown), a decimator/filter 370, a data demodulator 372, a data modulator/filter 374, a pair of sigma-delta modulators (ΣΔ Mod) 376, a pair of low voltage differential output drivers (not shown), a serial peripheral interface (SPI) 346, and a GMSK data modulator 672 coupled together as shown and illustrated in FIG. 6C.

The GMSK data modulator 672 is not illustrated in FIG. 3D as being a part of the baseband DSP IC 306A. The GMSK data modulator 672 of the baseband DSP integrated circuit 306D generates a data signal. The output of the GMSK data modulator 672 is coupled into the input of a ROM 682 in order to control the selection of the carrier frequency generated by the local oscillator 338 within the radio transceiver IC 606A.

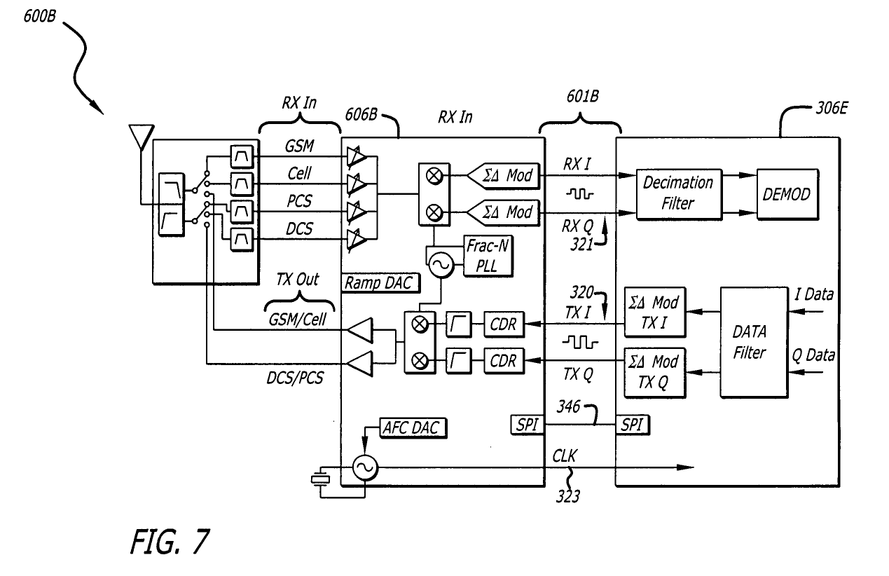

Referring now to FIG. 7, another embodiment of the invention is illustrated. FIG. 7 illustrates a system 600B including a radio transceiver integrated circuit (IC) 606B, and a baseband digital signal processing (DSP) IC 306E coupled together as shown to support multiple wireless communication system, sometimes referred to as multimode. The system 600B of FIG. 7 may support four wireless communication systems (i.e., quadband) including an EDGE or GAIT system. The system 600B may also be used to support AMPS, PCS, and DCS wireless communication systems. Alternative embodiments may be achieved from that illustrated in FIG. 7 by reducing the number and type of wireless communications systems supported so that combinations of single, dual, and triple bands may be supported instead of the quad band wireless communications systems illustrated.

As one aspect of the invention, the system 600B includes a digital interface 601B between the radio integrated circuit (e.g., the radio transceiver IC 606B) and the baseband digital signal processing (DSP) IC 306E. The digital interface 601B in the system 600B of FIG. 7 is one or more receive channels 321 and one or more transmit channels 320. Each channel is a digital serial bit stream. Each channel may communicate using a low voltage swing differential signal, in which case two wire traces are used for each. The one or more receive channels 321 include a RX I channel and a RX Q channel for complex data including imaginary and real terms. In an alternate embodiment, the RX I channel and a RX Q channel may be interleaved into one RX channel. The one or more transmit channels 320 include a TX I channel and a TX Q channel for complex data including imaginary and real terms. In an alternate embodiment, the TX I channel and a TX Q channel may be interleaved into one TX channel.

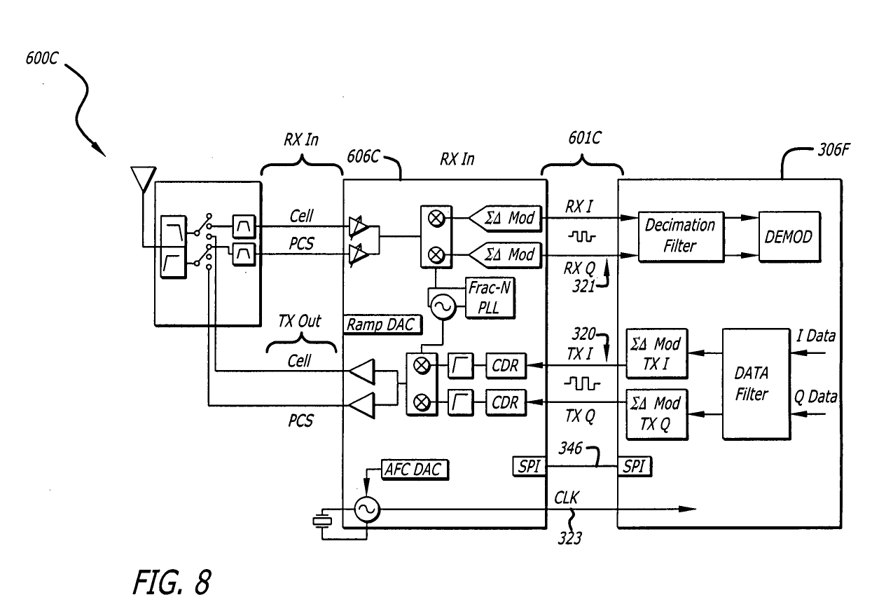

Referring now to FIG. 8, another embodiment of the invention is illustrated. FIG. 8 illustrates a system 600C including a radio transceiver integrated circuit (IC) 606C, and a baseband digital signal processing (DSP) IC 306F coupled together as shown to support multiple wireless communication system, sometimes referred to as multimode. The system 600C of FIG. 8 may support two wireless communication systems (i.e., dualband) including TDMA (i.e., PCS) and AMPS wireless communication systems. An alternative embodiment may be achieved from that illustrated in FIG. 8 by eliminating the AMPS system so that only a TDMA (i.e., PCS) wireless communication system is supported as a single band system.

As one aspect of the invention, the system 600C includes a digital interface 601C between the radio integrated circuit (e.g., the radio transceiver IC 606C) and the baseband digital signal processing (DSP) IC 306F. The digital interface 601C in the system 600C of FIG. 8 is one or more receive channels 321 and one or more transmit channels 320. Each channel is a digital serial bit stream. Each channel may communicate using a low voltage swing differential signal, in which case two wire traces are used for each. The one or more receive channels 321 include a RX I channel and a RX Q channel for complex data including imaginary and real terms. In an alternate embodiment, the RX I channel and a RX Q channel may be interleaved into one RX channel. The one or more transmit channels 320 include a TX I channel and a TX Q channel for complex data including imaginary and real terms. In an alternate embodiment, the TX I channel and a TX Q channel may be interleaved into one TX channel.

Referring now to FIG. 9A, a block diagram of the receive channel 321 of the digital interfaces 301A-301D, 601A-601D (referred to collectively as interface 301,601) is illustrated in greater detail between the radio frequency integrated circuits 302A-302D,606A-606D (referred to collectively as radio frequency integrated circuit 302,606) and the baseband digital signal processing ICs 306A-306F (referred to collectively as baseband digital signal processing IC 306). The in-phase or real component (I) receive channel and the quadrature or imaginary component (Q) receive channel of the receive channel 321 are mirror images of one another but carry different data.

In the radio frequency IC 302,606, the I receive channel includes a mixer or down-converter 902I, a programmable gain amplifier (PGA) 904I, an analog prefilter 906I, a sigma-delta modulator 908I, and a low voltage differential output driver 910I coupled in series together. The low voltage differential output driver 910I couples to a pair of wire traces between the radio frequency integrated circuit 302,606 and the baseband digital signal processing IC 306 to carry the differential signal there-between. The Q receive channel in the radio frequency IC 302,606 includes a mixer or down-converter 902Q, a programmable gain amplifier (PGA) 904Q, an analog prefilter 906Q, a sigma-delta modulator 908Q, and a low voltage differential output driver 910Q coupled in series together. The low voltage differential output driver 910Q couples to a pair of wire traces between the radio frequency integrated circuit 302,606 and the baseband digital signal processing IC 306 to carry the differential signal there-between.

The radio frequency IC 302,606, further includes a clock synthesizer 927 to couple to an external quartz crystal 926, and a local oscillator 928 coupled to the clock synthesizer 927 to generate a sigma-delta clock 929 for the sigma-delta modulators 908I,908Q.

In the baseband DSP IC 306, the I receive channel includes a low voltage differential input receiver 914I, a data synchronizer 915I, a decimator 916I, an equalizer 918I, and a matched filter 920I coupled in series together. The Q receive channel in the baseband DSP IC 306 includes a low voltage differential input receiver 914Q, a data synchronizer 915Q, a decimator 916Q, an equalizer 918Q, and a matched filter 920Q coupled in series together.

The baseband DSP IC 306 further includes a clock regenerator 930 to generate a local clock signal 931 from the reference clock signal 323, a clock divider 932 to divide the frequency of the local clock signal 931 by K down to a frequency of a digital channel filter clock 934, and a demodulator 922 to couple to the matched filters 920I, 920Q. The demodulator 922 receives data from both the I and Q receive channels to form a received digital data signal (DATA RCV) 923.

In the RF IC 302,606, the mixers 902I,902Q are used to down convert the received I and Q analog data signals from the carrier frequencies of the respective communication system channel into baseband signals. That is, the mixers strip away the carrier frequency from the I and Q analog signals. In other words, the mixers extract the analog data signals at baseband frequency from the received analog signals at the carrier frequencies. The programmable gain amplifiers 904I,904Q, are used to adjust the gain and effectively compress the dynamic range in front of the sigma-delta data modulators 908I,908Q.

Limited passive analog filtering is employed within the RF ICs. Channel filtering is realized entirely in the digital domain by digital filters in the baseband DSP IC. The design is optimized such that the filtering performed in the digital domain by digital filters in the baseband DSP IC removes the undesired signals and with no extra effort. The digital filters in the baseband DSP IC also filter out the inherent quantization noise added to the signal by the single bit modulation performed by the sigma-delta modulators 908I,908Q.

The analog prefilters 906I,906Q are passive analog filters that protect the sigma-delta data modulators 908I,908Q from high interference signals. The passive analog prefilters 906I,906Q are low-pass filters in the baseband frequency of interest. These passive analog prefilters 906I,906Q filter out the unwanted frequency of signals generated by the down converters 902I,902Q.

The sigma-delta modulators 980I,908Q are over sampling quantizers and essentially convert an analog signal into a serial digital bit stream. In comparison with the baseband signal, the sigma-delta modulators 980I,908Q over sample the analog signal at a rate much greater than the Nyquest rate in response to the frequency of the sigma-delta clock 929. The analog signal is quantized into two levels as a digital signal with a high voltage swing between a pair of high voltage difference logic levels (e.g., ground and VCC or −VCC and +VCC). Over time as more samples of the analog signal are taken by the sigma-delta modulators 980I,908Q, a single ended serial digital bit stream is formed having the high voltage swing.

The frequency of the sigma-delta clock 929 and the sampling rate of the sigma-delta modulators 980I,908Q varies depending upon the type of wireless communication system and its frequency bands. The following table illustrates exemplary Chip rates, exemplary sampling rates, and exemplary data rates of the I and Q components for exemplary wireless communication systems, such as WCDMA, TD-SCDMA, GSM/EDGE, N-CDMA and GPS wireless communication systems:

| | SYSTEM | | | | |
|---|---|---|---|---|---|
| | | | GSM/ | N- | |
| | WCDMA | TD_SCDMA | EDGE | CDMA | GPS |
| CHIP RATE | 3.84 | 1.28 | 0.270833/ | 1.2288 | 1.023 |
| Mc/s | | | 0.8125 | | |
| SAMPLING | 153.6 | 51.2 | 26 | 49.152 | 147.312 |
| RATE MHz | | | | | |
| I & Q NRZ | 153.6 | 51.2 | 26 | 49.152 | 147.312 |
| DATA | | | | | |
| RATE | | | | | |
| Mb/s | | | | | |

For example consider the WCDMA mode of the system to support the WCDMA wireless communication system. The receive signals are over sampled by a one bit fourth order sigma-delta modulator (e.g., modulators 908I,908Q) clocked as high as 153.6 MHz. The digital bit stream out of the modulators 908I,908Q is transported across the interface 301,601. Over the interface 301,601 the data need not be encoded in that the data is single bit NRZ serial data stream. The logic of the sigma-delta modulator 908I,908Q may assure that a bit change occurs in the single bit NRZ serial data stream at least once for every 32 bits. As the digital interface 301, 601 is a serial bit stream with no packetizing of data, a data exchange protocol need not be used across the interface to recover the data on each side. Moreover, the digital interface 301,601 may be unidirectional when data is only to be transmitted or received.

The over sampling clock for the modulator/demodulator may be separately generated within the RF IC 302,606 (e.g., sigma delta clock 929) and the baseband DSP IC 306 (e.g., local clock signal 931). In this case, clocks at the bit rates are not explicitly exchanged between the RF IC 302, 606 and the baseband DSP IC 306. Instead, a common low reference frequency may be used to internally generate a clock at the bit rates in order to reduce noise. The typical reference frequency is a crystal frequency around 20 MHz, while the data rate over the digital interface 301,601 can be above 200 MHz.

In order to recover data, the receiving side of the interface 301,601 uses a data synchronizer 915I,915Q, such as a delay lock loop (DLL), to retrieve the mid sampling point of the serial I and Q bit streams transferred over the interface.

The I and Q bit streams are transported separately in the typical implementation over the interface between the radio frequency integrated circuits and the baseband DSP integrated circuit. However, in the invention, I and Q may also be interleaved onto the same pair of differential serial signal lines. With respect to polarity, the I component leads the Q component for negative frequency deviations.

The low voltage differential output drivers 910I,910Q receive the single ended serial digital bit stream (I and Q bit streams) from the sigma-delta modulators 908I,908Q having the high voltage swing between the pair of high voltage difference logic levels (e.g., ground and VCC). In response to the single ended digital signal with the high voltage swing between the pair of high voltage difference logic levels, the low voltage differential output drivers 910I,910Q generate a double ended low voltage swing differential signal between a pair of low voltage difference logic levels.

In one embodiment, the low voltage differential output drivers 910I,910Q can generate logic levels and the low voltage differential input receivers 914I,914Q can receive logic levels in accordance with a modified LVDS standard of differential signals. In which case, the electrical characteristics of these modified LVDS signals communicated over the interface 303,601 are:

| PARAMETER | CONDITIONS | MIN | TYP | MAX | UNIT |
|---|---|---|---|---|---|
| Output | | 1.125 | 1.2 | 1.275 | V |
| Common | | | | | |
| Mode | | | | | |
| Output | | 0.112 | 0.14 | 0.168 | Vp |
| Differential | | | | | |
| Swing | | | | | |
| Single Ended | High current | 92 | 115 | 138 | Ω |
| Output | mode: | | | | |
| Resistance | | | | | |
| Single Ended | Lower current | | 230 | | Ω |
| Output | mode: | | | | |
| Resistance | | | | | |
| Eye pattern | window measured | 4 | 5 | | ns |
| opening | at +/− 20% | | | | |
| | of max swing | | | | |
| | I Q mode | | | | |
| | window measured | 1 | 1.5 | | ns |
| | at +/− 20% | | | | |
| | of max swing | | | | |
| | interleaved mode | | | | |

The LVDS standard is described in an American National Standards Institute specification titled “Electrical Characteristics of Low Voltage Differential Signaling (LVDS) Interface Circuits” published on Jan. 1, 2001 as ANSI TIA/EIA-644-A.

In comparison with the standard LVDS (low voltage differential signaling) logic levels, the data rates of the digital interface 301,601 are lower, the routing distances of the signals are smaller, and there is no parallel loading involved. The digital interface 301,601 saves supply current by reducing the swing at the transmitter end to 140 mV typically, and by using a higher line impedance of 240 ohms differential.

In the baseband DSP IC 306, the low voltage differential input receivers 914I,914Q receive the low voltage swing differential signal generated by the low voltage differential output drivers' 910I,910Q of the RF IC 302,606. The low voltage differential input receivers 914I,914Q convert the low voltage swing differential signal into a single ended digital data signal having a high voltage swing between a pair of high voltage difference logic levels (e.g., ground and VDD).

The data synchronizers 915I,915Q are delay locked loops (DLL) on the receive side of the interface to align the phase of the local clock signal 931 with a phase of the transitions in the single ended digital data signal to properly sample the single ended digital data signal.

The decimators 916I,916Q are samplers that sample the single ended digital data signal to reduce the sampling rate of the digital data signal by K to match the frequency of the digital channel filter clock 934. The decimators 916I,916Q further filter and convert the serial bit stream into parallel words. The rate of conversion is a function of the sampling reduction factor K. Additionally, as the sampling rate is lowered, the number of bits in the parallel word increase. The serial bit stream to parallel word conversion provided by the decimators 916I,916Q is essentially a digital averaging process of the incoming serial bit stream and not an ordinary serial to parallel conversion.

The receiver filters 906I and 906Q are intentionally distorted in order to improve dynamic range and large signal handling characteristics of the overall system. To optimize the overall system design, passive analog filters (e.g., the analog prefilter 906I,906Q) with a low frequency pole were placed at about half the channel bandwidth (BW) of each wireless communication system. In order to compensate for the low frequency pole at half the channel bandwidth of each wireless communication system, the digital filter in the DSP IC, on top of its functions of decimation and channel filtering, performs equalization for the embedded analog poles. The equalizers 918I,918Q are programmable digital non-linear phase-filters programmed into the baseband DSP IC to equalize such data distortion generated by the analog prefilters and the wireless communication system and to remove intersymbol interference.

The matched filters 920I,920Q are programmable digital filters programmed into the baseband DSP IC that approximate the matched filter specific to each wireless communication system over which data is being communicated. The matched filter theoretically provides all the channel selectivity not provided in prior stages of the system to detect the digital data that is being received over the interface 301,601 and the wireless communication system. The order of the matched filters 920I,920Q is appropriately selected to meet the system specifications when combining the Analog Prefilters 906I,906Q; the equalizers 918I,918Q; and the limited order matched filters 920I,920Q together.

The single bit stream of the digital interface 301,601 enables the system to tolerate small residual bit errors in the bit stream with no loss of data.

In one embodiment, an internal clock generator is used in the radio frequency integrated circuit to generate the clock signal 323 to synchronize the radio frequency integrated circuit and the digital signal processing integrated circuit. In another embodiment, the internal clock generator may be within the digital signal processing integrated circuit to generate the clock signal 323 which would then be coupled to the radio frequency integrated circuit. In yet another embodiment, the clock signal 323 can be generated externally from the radio frequency integrated circuit and the digital signal processing integrated circuit.

Referring now to FIG. 9B, a block diagram of an alternate embodiment of clock generation and synchronization between the radio integrated circuit (IC) and the baseband digital signal processing (DSP) IC is illustrated. A reference clock signal 323′ is generated externally from the radio frequency integrated circuit 302,606 and the digital signal processing integrated circuit 306 by a clock generator 950. A quartz crystal 926 may be coupled to the clock generator 950 to generate an accurate reference clock signal 323′.

The reference clock signal 323′ is coupled into the radio frequency integrated circuit 302,606 and the digital signal processing integrated circuit 306 to synchronize the circuits for the serial digital data flow between each. The baseband DSP IC 306 includes the clock regenerator 930 to generate a local clock signal 931 from the reference clock signal 323′. In this case, the radio frequency IC 302,606 may include a clock regenerator 953 to generate a local clock signal 955 from the reference clock signal 323′. The local clock signal 955 is coupled into the synthesizer 927 and other circuits of the radio frequency integrated circuit 302,606. The local clock signal 931 within the baseband DSP IC 306 is coupled into the data synchronizer 915Q, the decimator 916Q, the clock divider 932, and other circuits therein.

This alternate method of clock generation and synchronization illustrated in FIG. 9B may be applied to the embodiments of the invention previously described, such as those described with reference to FIGS. 3A-8.

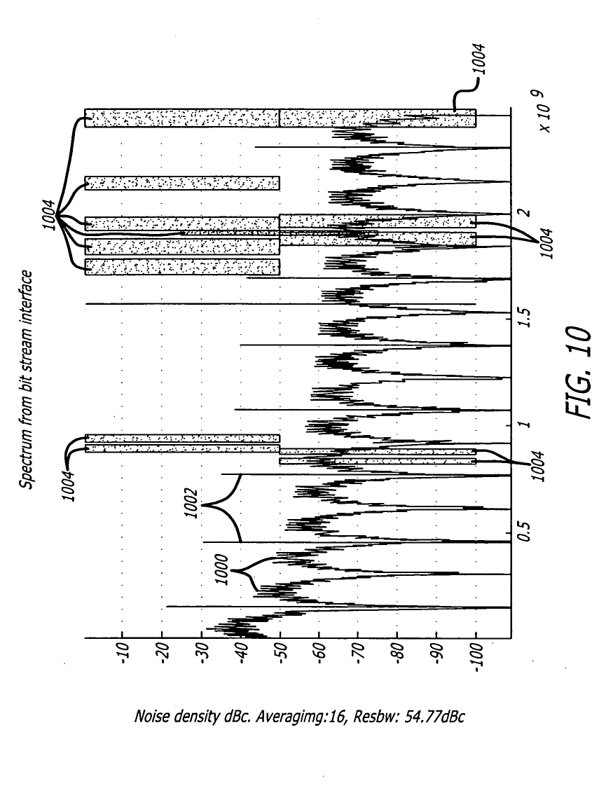

Referring now to FIG. 10, a graph illustrating a simulation of the digital interface is illustrated. The graph of FIG. 10 illustrate interference levels or the noise density provided by the digital serial bit stream of the digital interface in comparison with a 153.6 megaHertz (MHz) clock. The data spectrum is illustrated by the waveform 1000 and has periodic peaks. The periodic peaks in the waveform 1000 are worst case. The clock spectrum illustrated by the waveform 1002 and has periodic peaks. The data spectrum density is much less than the clock noise density. Thus, the digital interface of the invention between the radio frequency IC and the baseband DSP IC has low spurious emission and introduces very little noise into the system. The boxes 1004 overlaid on the spectral densities represent cellular phone frequency bands for wireless communication systems utilized in various countries. The interference spectrum and levels from the high-speed digital interface 301,601 has been simulated and shown to be compatible with the radio specifications of wireless communication systems.

The invention simplifies end user software development as one radio platform can be used for multiple products. The invention further allows digital matching of analog imperfections, such as predistortion of transmitters, nonlinearities in the receiver, intentionally distort signals to better handle interference. The invention enables a low power consumption because digital filters as well as analog circuitry can be implemented on the most optimized process technology.

The invention has been described with respect to mobile units, such as cellular telephones. However, the invention is equally applicable to stationary units, such as base stations for cellular telephone communication systems. Moreover, the digital interface 301,601 may be applied to other circuitry in radios including baseband audio codec circuitry, and other analog functions in order to lower costs and lower power consumption.

Moreover, the invention has been described and illustrated as using sigma-delta modulators. Other modulators that receive an analog input signal and have a single bit output to provide a serial digital data stream may be used. For example, the sigma-delta modulators may be delta modulators, in another embodiment. In yet another embodiment, the sigma-delta modulators may be modulating analog-to-digital converters with a single digital bit output to provide the serial bit stream.

Additionally, while certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. For example, it is possible to implement the invention or some of its features in hardware, firmware, software or a combination thereof where the software is provided in a processor readable storage medium such as magnetic, optical, or semiconductor storage. While the invention has been described in particular embodiments, the invention should not be construed as limited by such embodiments. Rather, the invention should be construed according to the claims below.

1. A system comprising:
a radio frequency integrated circuit including
a single bit modulator to convert an analog signal into a serial digital bit stream, and
an output driver coupled to the single bit sigma delta modulator, the output driver to drive the serial digital bit stream out from the radio frequency integrated circuit; and
a digital signal processing integrated circuit including
an input receiver coupled to the output driver of the radio frequency integrated circuit, the input receiver to receive the serial digital bit stream, and
a decimator coupled to the input receiver, the decimator to receive the serial digital bit stream, lower a sampling rate of the serial digital bit stream and convert the serial digital bit stream into parallel digital data samples.

2. The system of claim 1, wherein
the digital signal processing integrated circuit further includes
a demodulator to digitally demodulate the parallel digital data samples into data words for further signal processing by the digital signal processing integrated circuit.

3. The system of claim 1, wherein
the single bit modulator is a single bit sigma delta modulator.

4. The system of claim 1, wherein
the single bit modulator is a single bit delta modulator.

5. The system of claim 1, wherein
the single bit modulator is a single bit analog to digital converter and a modulator coupled together.

6. The system of claim 1, wherein
the output driver has a low voltage output swing, the output driver to drive the serial digital bit stream out of the radio frequency integrated circuit with the low voltage output swing.

7. The system of claim 6, wherein
the input receiver to receive the serial digital bit stream with the low voltage output swing.

8. The system of claim 7, wherein
the input receiver further to increase the low voltage output swing of the serial digital bit stream within the digital signal processing integrated circuit.

9. The system of claim 6, wherein
the low voltage output swing between a high logic level and a low logic level is less than an output swing between a high logic level and a low logic level of a three volt complementary metal oxide semiconductor (CMOS) process technology.

10. The system of claim 6, wherein
the low voltage output swing between a high logic level and a low logic level is less than an output swing between a high logic level of 1.8 volts and a low logic level of 0.2 volts.

11. The system of claim 8, wherein
the output driver translates first voltage levels of a first output voltage swing of the serial digital bit stream into second voltage levels with a second output voltage swing less than the first output voltage swing, and
the input receiver translates the second voltage levels of the second output voltage swing into third voltage levels with a third output voltage swing greater than the second output voltage swing.

12. The system of claim 11, wherein
the third voltage levels are substantially the same as the first voltage levels.

13. The system of claim 1, wherein
the output driver is double ended and generates a differential signal to represent the serial digital bit stream, and
the input receiver has a differential input to receive the differential signal to represent the serial digital bit stream.

14. The system of claim 13, wherein
the output driver is a low voltage differential signaling transmitter to generate a low voltage differential output signal with a low voltage differential swing, and
the input receiver is a low voltage differential signaling receiver to receive the low voltage differential output signal with the low voltage differential swing.

15. The system of claim 14, wherein
the low voltage differential swing is at least 100 milli-volts.

16. The system of claim 1, wherein
the serial digital bit stream is a rectangular waveform.

17. The system of claim 1, wherein
the radio frequency integrated circuit is a receiver.

18. The system of claim 1, wherein
the radio frequency integrated circuit is a transceiver.

19. The system of claim 1, wherein
a delta sigma clock is coupled to the single bit sigma delta modulator, a frequency of the delta sigma clock to provide a data rate in the serial digital bit stream.

20. The system of claim 19, wherein
the frequency of the delta sigma clock is programmable to provide various data rates in the serial digital bit stream for various wireless communication systems.

21. The system of claim 1, wherein
a low frequency reference clock couples between the radio frequency integrated circuit and the digital signal processing integrated circuit to synchronize clock signals of each.

22. The system of claim 21, wherein
the low frequency reference clock synchronizes a sigma delta clock of the radio frequency integrated circuit with a local clock of the digital signal processing integrated circuit.

23. A radio frequency integrated circuit comprising:
at least one gain amplifier to couple to an antenna to receive a first wireless radio frequency signal of a first selectable carrier frequency;
at least one down converter coupled to the at least one gain amplifier, the at least one down converter to extract a first analog signal from the first wireless radio frequency signal;
at least one single bit sigma delta modulator coupled to the at least one down converter, the at least one single bit sigma delta modulator to convert the first analog signal into a first serial digital bit stream; and
at least one output driver coupled to the at least one single bit sigma delta modulator, the at least one output driver to provide a low voltage output swing of the first serial digital bit stream to reduce noise generation as the first serial digital bit stream is coupled to another integrated circuit.

24. The radio frequency integrated circuit of claim 23, further comprising
a second gain amplifier to couple to the antenna to simultaneously receive a third wireless radio frequency signal of a third selectable carrier frequency;
a second down converter coupled to the second gain amplifier, the second down converter to extract a third analog signal from the third wireless radio frequency signal;
a second single bit sigma delta modulator coupled to the second down converter, the second single bit sigma delta modulator to convert the third analog signal into a third serial digital bit stream; and
a second output driver coupled to the second single bit sigma delta modulator, the second output driver to provide a low voltage output swing of the third serial digital bit stream to reduce noise generation as the third serial digital bit stream is coupled to another integrated circuit.

25. The radio frequency integrated circuit of claim 23, wherein
the at least one gain amplifier is a variable gain amplifier or a switched gain amplifier.

26. The radio frequency integrated circuit of claim 24, wherein
the at least one gain amplifier and the second gain amplifier are variable gain amplifiers or switched gain amplifiers.

27. The radio frequency integrated circuit of claim 23, wherein
the radio frequency integrated circuit is a radio frequency receiver integrated circuit.

28. The radio frequency integrated circuit of claim 23, wherein
the radio frequency integrated circuit is a transceiver and further includes,
an input receiver to receive a second serial digital bit stream to be transmitted;
a data recoverer coupled to the input receiver, the data recoverer to recover digital data bits from the second serial digital bit stream;
a low pass filter coupled to the data recoverer, the low pass filter to convert the digital data bits into a second analog signal;
a mixer coupled to the low pass filter, the mixer to up-convert the second analog signal from a baseband frequency to a second selectable carrier frequency as a second wireless radio frequency signal; and
an amplifier coupled to the mixer, the amplifier to amplify the second wireless radio frequency signal for broadcast over the antenna.

29. The radio frequency integrated circuit of claim 28, wherein
the first selected carrier frequency and the second selected carrier frequency are selected from a set of carrier frequencies of a first selected wireless communication system.

30. The radio frequency integrated circuit of claim 29, wherein
the selected wireless communication system is selected from the set of Universal Mobile Telecommunication System (UMTS), Global System for Multiple Communication (GSM), GSM Mobile Application Part (GSM-MAP), General Packet Radio Protocol System or General Packet Radio Service (GPRS), Enhanced Data GSM Environment (EDGE), (GAIT), Orthogonal Frequency-Division Multiplexing (OFDM), Code Orthogonal Frequency Division Multiplexing (COFDM), Block Coding, Convolutional Coding, Turbo Coding, Trellis Coding, Gaussian Minimum Shift Keying (GMSK), Quadrature Phase Shift Keying (QPSK), Quadrature Amplitude Modulation (QAM), Frequency Modulation (FM), Frequency Division Multiple Access (FDMA), Time Division Multiple Access (TDMA), Code Division Multiple Access (CDMA), Narrowband CDMA (N-CDMA), Wideband CDMA (W-CDMA), CDMA2000, CDMA2000-1XEV, CDMA2000-EVDO, CDMA 2000-EDV, Time Division-Synchronized Code Division Multiple Access (TD-SCDMA), Third-Generation Partnership Project (3GPP TDD), International Mobile Telecommunication (IMT), IMT2000MC, IMT2000DS, IMT2000SC, IMT2000TC, Personal Communication System (PCS), Digital Communication System (DCS), Personal Digital Cellular (PDC), Digital Enhanced Cordless Telecommunications (DECT), Advanced Mobile Phone System (AMPS), Wireless Local Area Network (LAN) (IEEE 802.11a, IEEE 802.11b, IEEE 802.11g), and Global Positioning System (GPS).

31. The radio frequency integrated circuit of claim 29, wherein
the first selected carrier frequency is selected from a set of carrier frequencies of a Universal Mobile Telecommunication System (UMTS), Global System for Multiple Communication (GSM), GSM Mobile Application Part (GSM-MAP), General Packet Radio Protocol System or General Packet Radio Service (GPRS), Enhanced Data GSM Environment (EDGE), (GAIT), Orthogonal Frequency-Division Multiplexing (OFDM), Code Orthogonal Frequency Division Multiplexing (COFDM), Gaussian Minimum Shift Keying (GMSK), Quadrature Phase Shift Keying (QPSK), Quadrature Amplitude Modulation (QAM), Frequency Modulation (FM), Frequency Division Multiple Access (FDMA), Time Division Multiple Access (TDMA), Code Division Multiple Access (CDMA), Narrowband CDMA (N-CDMA), Wideband CDMA (W-CDMA), CDMA2000, CDMA2000-1XEV, CDMA2000-EVDO, CDMA2000-EDV, Time Division-Synchronized Code Division Multiple Access (TD-SCDMA), Third-Generation Partnership Project (3GPP TDD), International Mobile Telecommunication (IMT), IMT2000MC, IMT2000DS, IMT2000SC, IMT2000TC, Personal Communication System (PCS), Digital Communication System (DCS), Personal Digital Cellular (PDC), Digital Enhanced Cordless Telecommunications (DECT), Advanced Mobile Phone System (AMPS), Wireless Local Area Network (LAN) (IEEE 802.11a, IEEE 802.11b, IEEE 802.11g), and Global Positioning System (GPS), and
the second selected carrier frequency is selected from a set of carrier frequencies of Universal Mobile Telecommunication System (UMTS), Global System for Multiple Communication (GSM), GSM Mobile Application Part (GSM-MAP), General Packet Radio Protocol System or General Packet Radio Service (GPRS), Enhanced Data GSM Environment (EDGE), (GAIT), Orthogonal Frequency-Division Multiplexing (OFDM), Code Orthogonal Frequency Division Multiplexing (COFDM), Gaussian Minimum Shift Keying (GMSK), Quadrature Phase Shift Keying (QPSK), Quadrature Amplitude Modulation (QAM), Frequency Modulation (FM), Frequency Division Multiple Access (FDMA), Time Division Multiple Access (TDMA), Code Division Multiple Access (CDMA), Narrowband CDMA (N-CDMA), Wideband CDMA (W-CDMA), CDMA2000, CDMA2000-1XEV, CDMA2000-EVDO, CDMA2000-EDV, Time Division-Synchronized Code Division Multiple Access (TD-SCDMA), Third-Generation Partnership Project (3GPP TDD), International Mobile Telecommunication (IMT), IMT2000MC, IMT2000DS, IMT2000SC, IMT2000TC, Personal Communication System (PCS), Digital Communication System (DCS), Personal Digital Cellular (PDC), Digital Enhanced Cordless Telecommunications (DECT), Advanced Mobile Phone System (AMPS), and Wireless Local Area Network (LAN) (IEEE 802.11a, IEEE 802.11b, IEEE 802.11g).

32. A radio frequency integrated circuit comprising:
an input receiver to receive a serial digital transmission bit stream with a reduced output voltage swing, the input receiver to increase the output voltage swing of the serial digital transmission bit stream in the radio frequency integrated circuit;
a data recoverer coupled to the input receiver, the data recoverer to recover digital data bits from the serial digital transmission bit stream;
a low pass filter coupled to the data recoverer, the low pass filter to convert the digital data bits into an analog transmission signal;
a mixer coupled to the low pass filter, the mixer to up-convert the analog transmission signal from a baseband frequency to a selectable carrier frequency as a transmit radio frequency signal; and
an amplifier coupled to the mixer, the amplifier to amplify the transmit radio frequency signal for broadcast over an antenna.

33. The radio frequency integrated circuit of claim 32, wherein
the radio frequency integrated circuit is a transmitter.

34. A method for a wireless radio, the method comprising:
receiving a first wireless radio signal;
extracting a first analog signal from the first wireless radio signal;
converting the first analog signal into a first serial digital data signal;
providing a low voltage output swing in the first serial digital data signal; and
transmitting the first serial digital data signal with the low voltage output swing from a radio frequency (RF) integrated circuit to a digital signal processing (DSP) integrated circuit.

35. The method of claim 34, further comprising:
receiving a second wireless radio signal;
extracting a second analog signal from the second wireless radio signal;
converting the second analog signal into a second serial digital data signal;
providing a low voltage output swing in the second serial digital data signal; and
transmitting the second serial digital data signal with the reduced output voltage swing from the radio frequency integrated circuit to the digital signal processing (DSP) integrated circuit.

36. The method of claim 35, wherein
the first wireless radio signal and the second wireless radio signal are simultaneously received.

37. The method of claim 35, wherein
the first analog signal and the second analog signal are simultaneously extracted.

38. The method of claim 35, wherein
the first wireless radio signal is received during the time period that the second wireless radio signal is received.

39. The method of claim 35, wherein
the first analog signal is extracted during the time period that the second analog signal is extracted.

40. The method of claim 35, further comprising:
receiving a third wireless radio signal;
extracting a third analog signal from the third wireless radio signal;
converting the third analog signal into a third serial digital data signal;
providing a low voltage output swing in the third serial digital data signal; and
transmitting the third serial digital data signal with the low output voltage swing from a radio integrated circuit to a digital signal processing (DSP) integrated circuit.

41. The method of claim 40, wherein
the first wireless radio signal, the second wireless radio signal, and the third wireless radio signal are simultaneously received.

42. The method of claim 41, wherein
the first analog signal, the second analog signal, and the third analog signal are simultaneously extracted.

43. The method of claim 34, further comprising:
receiving the first serial digital data signal with the reduced output voltage swing;
increasing the output voltage swing in the first serial digital data signal;
reducing a sampling frequency of the first serial digital data signal; and
converting the first serial digital data signal into a parallel digital data signal for processing by the DSP integrated circuit.

44. The method of claim 34, wherein
the converting of the first analog signal into the first serial digital data signal is a delta-sigma modulation of the first analog signal into the first serial digital data signal.

45. The method of claim 43, further comprising:
recovering data words from the parallel digital data signal by digital demodulation for a predetermined wireless communication system.

46. The method of claim 34, wherein
the transmitting of the first serial digital data signal is over a single wire.

47. The method of claim 34, wherein
the first serial digital data signal is a differential data signal, and
the transmitting of the first serial digital data signal is over a pair of wires.

48. The method of claim 34, wherein
the first serial digital data signal is a complex differential data signal and the transmitting of the first serial digital data signal is over two pairs of wires,
a first differential data signal of the first serial digital data signal is transmitted over the first pair of wires, and
a second differential data signal of the first serial digital data signal is transmitted over the second pair of wires.

49. The method of claim 48, wherein
the first differential data signal is a real component of a complex data signal, and
the second differential data signal is an imaginary component of the complex data signal.

50. The method of claim 48, wherein
the first differential data signal is an in-phase signal, and
the second differential data signal is a quadrature signal with respect to the in-phase signal.

51. The method of claim 34, wherein
the first serial digital data signal is a multiphase differential data signal and the transmitting of the first serial digital data signal is over two pairs of wires,
a magnitude data signal of the first serial digital data signal is transmitted over the first pair of wires, and
a phase data signal of the first serial digital data signal is transmitted over the second pair of wires.

52. The method of claim 34, further comprising:
receiving a fourth serial digital data signal from the DSP integrated circuit for transmission over a wireless communication system;
converting the fourth serial digital data signal from the DSP integrated circuit into a fourth analog signal;
up-converting the fourth analog signal to a selectable carrier frequency; and
transmitting the fourth analog signal through the antenna as a fourth wireless radio frequency signal.

53. The method of claim 52, wherein
the fourth serial digital data signal from the DSP integrated circuit is a low voltage output swing signal, and the method further includes
increasing the low voltage output swing in the fourth serial digital data signal from the DSP integrated circuit.

54. A data signal flow between a radio frequency integrated circuit and a digital signal processing (DSP) integrated circuit, the data signal flow comprising:
a first serial digital data signal flowing from the radio frequency integrated circuit to the DSP integrated circuit, the first serial digital data signal representing a first received data signal from a first wireless communication system; and
a second serial digital data signal flowing from the radio frequency integrated circuit to the DSP integrated circuit, the second serial digital data signal representing a second received data signal from a second wireless communication system.

55. The data signal flow of claim 54, wherein
the first serial digital data signal is a complex differential data signal flowing over two pairs of wires,
an in-phase differential data signal of the first serial digital data signal flows over a first pair of wires, and
a quadrature differential data signal with respect to the in-phase differential data signal of the first serial digital data signal flows over a second pair of wires.

56. The data signal flow of claim 54, wherein
the first serial digital data signal is a multiphase differential data signal flowing over two pairs of wires,
a magnitude data signal of the first serial digital data signal flows over a first pair of wires, and
a phase data signal of the first serial digital data signal flows over a second pair of wires.

57. The data signal flow of claim 54, further comprising:
a third serial digital data signal flowing from the DSP integrated circuit to the radio frequency integrated circuit, the third serial digital data signal representing a first transmit data signal for communication over the first wireless communication system.

58. The data signal flow of claim 57, wherein
the third serial digital data signal is a complex differential data signal flowing over two pairs of wires,
an in-phase differential data signal of the third serial digital data signal flows over a first pair of wires, and
a quadrature differential data signal with respect to the in-phase differential data signal of the third serial digital data signal flows over a second pair of wires.

59. The data signal flow of claim 57, wherein
the third serial digital data signal is a multiphase differential data signal flowing over two pairs of wires,
a magnitude data signal of the third serial digital data signal flows over a first pair of wires, and
a phase data signal of the third serial digital data signal flows over a second pair of wires.

60. The data signal flow of claim 54, wherein
the first serial digital data signal is a low voltage differential data signal flowing over at least one pair of wires.

61. The data signal flow of claim 57, wherein
the third serial digital data signal is a low voltage differential data signal flowing over at least one pair of wires.

62. The data signal flow of claim 54, wherein
a data rate of the first serial digital data signal is variable to adapt to a selected wireless communication system.

63. The data signal flow of claim 57, wherein
a data rate of the first serial digital data signal, a data rate of the second serial digital data signal, and a data rate of the third serial digital data signal are variable to adapt to selected wireless communication systems.

64. The data signal flow of claim 54, wherein
the first serial digital data signal and the second serial digital data signal simultaneously flow from the radio frequency integrated circuit to the DSP integrated circuit to simultaneously receive data over two wireless channels of communication.

65. The data signal flow of claim 57, wherein
the first serial digital data signal, the second serial digital data signal, and the third serial digital data signal simultaneously flow between the radio frequency integrated circuit and the DSP integrated circuit to
simultaneously receive data over two wireless channels of communication and
simultaneously transmit data over one wireless channel of communication.

66. A radio frequency integrated circuit comprising:
a plurality of gain amplifiers to couple to an antenna to simultaneously receive wireless radio frequency signals of selectable carrier frequencies;
a plurality of down converters coupled to the plurality of gain amplifiers, the plurality of down converters to simultaneously extract analog signals from the wireless radio frequency signals; and
a plurality of sigma delta modulators coupled to the plurality of down converters, the plurality of single bit sigma delta modulators to simultaneously convert the analog signals into serial digital bit streams; and
a plurality of output drivers coupled to the plurality of single bit sigma delta modulators, the plurality of output drivers to couple the serial digital bit streams to another integrated circuit.

67. The radio frequency integrated circuit of claim 66, wherein,
the plurality of output drivers further to reduce an output voltage swing of the serial digital bit streams to further reduce noise generation as the serial digital bit streams are coupled to the another integrated circuit.

68. The radio frequency integrated circuit of claim 66, wherein
the plurality of gain amplifiers are a variable gain amplifier or a switched gain amplifier.

69. The radio frequency integrated circuit of claim 66, wherein
the radio frequency integrated circuit is a transceiver and further includes,
an input receiver to receive a serial digital transmission bit stream from the another integrated circuit;
a data recoverer coupled to the input receiver, the data recoverer to recover digital data bits from the serial digital transmission bit stream;
a low pass filter coupled to the data recoverer, the low pass filter to convert the digital data bits into an analog transmission signal;
a mixer coupled to the low pass filter, the mixer to up-convert the analog transmission signal from a baseband frequency to a second selectable carrier frequency as a transmit radio frequency signal; and
an amplifier coupled to the mixer, the amplifier to amplify the transmit radio frequency signal for broadcast over the antenna.

70. The radio frequency integrated circuit of claim 69, wherein,
the serial digital transmission bit stream has a reduced output voltage swing to further reduce noise, and
the input receiver to increase the output voltage swing of the serial digital transmission bit stream in the radio frequency integrated circuit.

71. A system comprising:
a radio frequency integrated circuit including
a single bit sigma delta modulator with an analog input and a serial digital output, and
an output driver having an input coupled to the serial digital output of the single bit sigma delta modulator, the output driver having a differential output; and
a digital signal processing integrated circuit including
an input receiver coupled to the output driver of the radio frequency integrated circuit, the input receiver having a differential input to couple to the differential output of the output driver, the input receiver having a serial digital output.

72. The system of claim 71, wherein
the output driver to drive a serial digital bit stream out from the radio frequency integrated circuit with a low voltage differential output swing to lower noise.

73. The system of claim 72, wherein
the input receiver to receive the serial digital bit stream with the low voltage differential output swing.

74. The system of claim 71, wherein
the digital signal processing integrated circuit further includes
a decimator coupled to the serial digital output of the input receiver, the decimator having a parallel digital output, and
a demodulator coupled to the parallel digital output of the decimator.

75. A radio frequency integrated circuit comprising:
a gain amplifier having an input to couple to an antenna, the gain amplifier having an analog output;
a down converter having an analog input coupled to the analog output of the gain amplifier, the down converter having an analog output;
a single bit sigma delta modulator having an analog input coupled to the analog output of the down converter, the single bit sigma delta modulator having a serial digital output; and
an output driver having an input coupled to the serial digital output of the single bit sigma delta modulator, the output driver having a differential output.

76. The radio frequency integrated circuit of claim 75, wherein
the radio frequency integrated circuit is a radio frequency receiver integrated circuit.

77. The radio frequency integrated circuit of claim 75, wherein
the radio frequency integrated circuit is a transceiver and further includes,
an input receiver having a differential input, the input receiver having a serial digital output;
a data recoverer having an input coupled to the serial digital output of the input receiver, the data recoverer having a serial digital output;
a low pass filter having an input coupled to the serial digital output of the data recoverer, the low pass filter having an analog output;
a mixer having an input coupled to the analog output of the low pass filter, the mixer having an analog output; and
an amplifier having an input coupled to analog output of the mixer, the amplifier having an output to couple to the antenna.

78. A system comprising:
a radio frequency integrated circuit including
a modulating analog to digital converter with a single bit output, the modulating analog to digital converter to convert an analog input signal into a serial digital bit output stream, and
an output driver coupled to the single bit analog to digital converter, the output driver to drive the serial digital bit stream out from the radio frequency integrated circuit; and
a processor coupled to the radio frequency integrated circuit.

79. The system of claim 78, wherein
the processor includes
an input receiver coupled to the output driver of the radio frequency integrated circuit, the input receiver to receive the serial digital bit stream.

80. The system of claim 79, wherein
the processor is a digital signal processor and further includes
a decimator coupled to the input receiver, the decimator to receive the serial digital bit stream, lower a sampling rate of the serial digital bit stream, and convert the serial digital bit stream into parallel digital data samples, and
a demodulator to digitally demodulate the parallel digital data samples into data words for further signal processing by the digital signal processing integrated circuit.

81. The system of claim 79, wherein
the processor includes programmable instructions to provide
a decimator coupled to the input receiver, the decimator to receive the serial digital bit stream, lower a sampling rate of the serial digital bit stream, and convert the serial digital bit stream into parallel digital data samples; and
a demodulator coupled to the decimator, the demodulator to digitally demodulate the parallel digital data samples into data words for further signal processing by the digital signal processing integrated circuit.

82. A system comprising:
a radio frequency integrated circuit including
a modulating analog to digital converter with an analog input and a serial digital output, and
an output driver having an input coupled to the serial digital output of the modulating analog to digital converter, the output driver having a digital output; and
a processor coupled to the radio frequency integrated circuit.

83. The system of claim 82, wherein
the processor includes
an input receiver coupled to the digital output of the output driver of the radio frequency integrated circuit, the input receiver having a digital input to couple to the digital output of the output driver, the input receiver having a serial digital output.

84. The system of claim 83, wherein
the processor is a digital signal processor and further includes
a decimator coupled to the serial digital output of the input receiver, the decimator having a digital output, and
a demodulator coupled to the digital output of the decimator.

85. The system of claim 83, wherein
the processor includes programmable instructions to provide
a decimator coupled to the serial digital output of the input receiver, the decimator having a digital output, and
a demodulator coupled to the digital output of the decimator.
